(19) United States
(12) Patent Application Publication
(10) Pub. No.: US 2022/0324057 A1
(43) Pub. Date: Oct. 13, 2022

(54) ADDITIVE MANUFACTURING APPARATUS, ADDITIVE MANUFACTURING METHOD, AND STORAGE MEDIUM

(71) Applicant: Mitsubishi Electric Corporation, Tokyo (JP)

(72) Inventors: Shigeru TAKUSHIMA, Tokyo (JP); Daiji MORITA, Tokyo (JP); Nobuyuki SUMI, Tokyo (JP); Satoshi HATTORI, Tokyo (JP); Takafumi FUJII, Tokyo (JP); Shun KAYASHIMA, Tokyo (JP)

(73) Assignee: Mitsubishi Electric Corporation, Tokyo (JP)

(21) Appl. No.: 17/623,636

(22) PCT Filed: Aug. 7, 2019
(86) PCT No.: PCT/JP2019/031218

§ 371 Date: Jun. 7, 2022

(51) Int. Cl. B23K 26/342; B23K 26/03; B23K 26/046; G01B 11/06; B22F 10/22; B22F 12/90; B22F 12/41; B22F 10/36; B33Y 10/00; B33Y 30/00; B33Y 50/02

(52) U.S. Cl. CPC B23K 26/342; B23K 26/032; B23K 26/046; G01B 11/0608; B22F 10/22; B22F 12/90; B22F 12/41; B22F 10/36; B33Y 10/00; B33Y 30/00; B33Y 50/02

(57) ABSTRACT

An additive manufacturing apparatus that forms an object by repeating additive machining of melting a machining material and adding, onto a workpiece, the machining material solidified includes: a height measurement unit that measures a height of the object formed at a machining position; and a control unit that controls a machining condition for adding the machining material to the machining position on the basis of a measurement result provided by the height measurement unit.

### FIELD

The present invention relates to an additive manufacturing apparatus, an additive manufacturing method, and an additive manufacturing program for forming an object by adding machining material onto a workpiece.

### BACKGROUND

Conventionally known additive manufacturing apparatuses such as three-dimensional (3D) printers use a technique called additive manufacturing (AM) that forms a three-dimensional object by stacking layers of machining material.

Patent Literature 1 discloses an additive manufacturing apparatus using directed energy deposition

(DED) as a method of stacking layers of metal machining material. The additive manufacturing apparatus using directed energy deposition described in Patent Literature 1 supplies a metal machining material such as metal wire or metal powder from a supply port to a machining position, and melts and deposits the machining material with a laser, an electron beam, or the like to form an object having a desired shape. A current is supplied to the wire which is the machining material, whereby a molten droplet is formed at the end of the wire. Then, the molten droplet is deposited in a molten pool formed on the workpiece, whereby an object is formed. This additive manufacturing apparatus controls the supply of current to the wire to melt the wire and separate droplets from the wire.

### CITATION LIST

### Patent Literature

Patent Literature 1: Japanese Patent Application Laid-open No. 2016-179501

### SUMMARY

### Technical Problem

For the additive manufacturing apparatus described in Patent Literature 1, the workpiece may be destroyed upon occurrence of an arc discharge between the wire and the workpiece. It is therefore necessary to precisely control the supply of current to the wire so as to prevent an arc discharge between the wire and the workpiece. However, controlling the supply of current to the wire so as to prevent an arc discharge may lead to insufficient separation of droplets from the wire, depending on machining conditions. This poses a problem of the created beads failing to have a uniform height, resulting in a deterioration in the shape accuracy of the object.

The present invention has been made in view of the above, and an object thereof is to obtain an additive manufacturing apparatus capable of improving the shape accuracy of an object.

### Solution to Problem

To solve the above problem and achieve the object, the present invention provides an additive manufacturing apparatus to form an object by repeating additive machining of melting a machining material and adding, onto a workpiece, the machining material solidified, the additive manufacturing apparatus comprising: a height measurement unit to measure a height of the object formed at a machining position; and a control unit to control a machining condition for adding the machining material to the machining position on a basis of a measurement result provided by the height measurement unit.

### Advantageous Effects of Invention

The present invention can achieve the effect of obtaining an additive manufacturing apparatus capable of improving the shape accuracy of an object.

### BRIEF DESCRIPTION OF DRAWINGS

FIG. 1 is a diagram illustrating a configuration of an additive manufacturing apparatus according to a first embodiment of the present invention.

FIG. 2 is a diagram illustrating dedicated hardware for implementing the functions of the calculation unit and the control unit illustrated in FIG. 1.

FIG. 3 is a diagram illustrating a configuration of a control circuit for implementing the functions of the calculation unit and the control unit illustrated in FIG. 1.

FIG. 4 is a diagram illustrating the internal configuration of the machining head illustrated in FIG. 1.

FIG. 5 is a flowchart for explaining an operation in which the additive manufacturing apparatus illustrated in FIG. 1 forms a ball bead.

FIG. 6 is a schematic cross-sectional diagram illustrating the machining area of the additive manufacturing apparatus illustrated in FIG. 1.

FIG. 7 is a schematic cross-sectional diagram in which the wire discharged to the machining area of the additive manufacturing apparatus illustrated in FIG. 1 is in contact with the additive target surface.

FIG. 8 is a schematic cross-sectional diagram in which the machining area of the additive manufacturing apparatus illustrated in FIG. 1 is irradiated with machining light.

FIG. 9 is a schematic cross-sectional diagram in which the supply of wire to the machining area of the additive manufacturing apparatus illustrated in FIG. 1 is started.

FIG. 10 is a schematic cross-sectional diagram in which the wire is pulled out from the machining area of the additive manufacturing apparatus illustrated in FIG. 1.

FIG. 11 is a schematic cross-sectional diagram in which the irradiation of the machining area of the additive manufacturing apparatus illustrated in FIG. 1 with machining light is stopped.

FIG. 12 is a schematic cross-sectional diagram in which the machining head of the additive manufacturing apparatus illustrated in FIG. 1 moves to the next machining point.

FIG. 13 is a schematic cross-sectional diagram for explaining a method of creating an object with the additive manufacturing apparatus illustrated in FIG. 1.

FIG. 14 is a diagram illustrating the height of the wire relative to the object that is formed by the additive manufacturing apparatus illustrated in FIG. 1.

FIG. 15 is a diagram schematically illustrating an XZ cross-section of the object on which illumination light is projected from the measurement illumination unit illustrated in FIG. 1.

FIG. 16 is a diagram illustrating the light-receiving position on the light-receiving element with the object irradiated with illumination light by the additive manufacturing apparatus illustrated in FIG. 1.

FIG. 17 is a flowchart for explaining a procedure for performing additive process, using the measurement result of the height of the object formed by the additive manufacturing apparatus illustrated in FIG. 1.

FIG. 18 is a diagram illustrating a method of controlling the wire supply speed when the additive manufacturing apparatus illustrated in FIG. 1 machines the second layer.

FIG. 19 is a diagram illustrating an example in which the machining condition that the additive manufacturing apparatus illustrated in FIG. 1 controls is the number of ball beads.

FIG. 20 is a diagram illustrating a method in which the additive manufacturing apparatus illustrated in FIG. 1 controls the wire height on the basis of the measurement result of the height of the object.

FIG. 21 is a diagram illustrating a modification of the shape of a bead formed by the additive manufacturing apparatus illustrated in FIG. 1.

FIG. 22 is a diagram illustrating a modification to the measurement position for measuring the height of the object formed by the additive manufacturing apparatus illustrated in FIG. 1.

FIG. 23 is a diagram for explaining the problem to be solved by an additive manufacturing apparatus according to a second embodiment of the present invention.

FIG. 24 is a flowchart for explaining machining position search process of the additive manufacturing apparatus according to the second embodiment of the present invention.

FIG. 25 is a diagram illustrating the positional relationship between the measurement illumination unit and a bead before the process of FIG. 24 starts.

FIG. 26 is a diagram illustrating the light-receiving position on the light-receiving element in the state illustrated in FIG. 25.

FIG. 27 is a diagram illustrating the positional relationship between the measurement illumination unit and the workpiece after step S301 in FIG. 24.

FIG. 28 is a diagram illustrating the light-receiving position on the light-receiving element in the state illustrated in FIG. 27.

FIG. 29 is a diagram illustrating the positional relationship between the measurement illumination unit and the workpiece after step S302 in FIG. 24.

FIG. 30 is a diagram illustrating the light-receiving position on the light-receiving element in the state illustrated in FIG. 29.

FIG. 31 is a diagram illustrating a predetermined range used in step S303 of FIG. 24.

FIG. 32 is a diagram in which the drive stage stops in step S304 of FIG. 24.

FIG. 33 is a diagram for comparing the state before the process of FIG. 24 and the state after step S304.

FIG. 34 is a diagram illustrating a configuration of an additive manufacturing apparatus according to a third embodiment of the present invention.

FIG. 35 is a diagram illustrating the internal configuration of the machining head illustrated in FIG. 34.

FIG. 36 is a diagram for explaining height measurement in the additive manufacturing apparatus illustrated in FIG. 34.

FIG. 37 is a diagram illustrating the light-receiving position of reflected light from the bead illustrated in FIG. 36(a).

FIG. 38 is a diagram illustrating the light-receiving position of reflected light from the bead illustrated in FIG. 36(b).

FIG. 39 is a diagram illustrating the light-receiving position of reflected light from the bead illustrated in FIG. 36(c).

FIG. 40 is a diagram illustrating a modification to the additive manufacturing apparatus illustrated in FIG. 35.

### DESCRIPTION OF EMBODIMENTS

An additive manufacturing apparatus, an additive manufacturing method, and an additive manufacturing program according to embodiments of the present invention will be hereinafter described in detail with reference to the drawings. The present invention is not limited to the embodiments.

### First Embodiment.

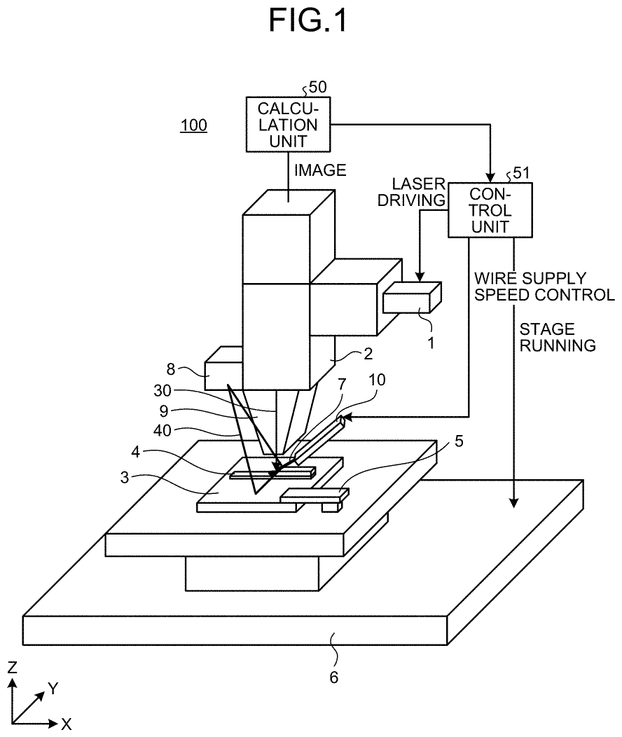

FIG. 1 is a diagram illustrating a configuration of an additive manufacturing apparatus 100 according to the first embodiment of the present invention. The additive manufacturing apparatus 100 is hereinafter discussed as a metal additive manufacturing apparatus that uses metal as a machining material, but may be an additive manufacturing apparatus that uses a machining material other than metal such as resin. In the following description, an object formed by the additive manufacturing apparatus 100 may also be referred to as a deposit. The additive manufacturing apparatus 100 performs the additive machining of melting machining material using a machining laser and adding the machining material to the surface of a target, i.e., a workpiece. However, the additive manufacturing apparatus 100 may use another machining method such as arc discharge.

The additive manufacturing apparatus 100 includes a machining laser 1, a machining head 2, a fixture 5 for fixing a workpiece 3, a drive stage 6, a measurement illumination unit 8, a gas nozzle 9, a machining material supply unit 10, a calculation unit 50, and a control unit 51.

The additive manufacturing apparatus 100 repeats the additive machining of melting a machining material 7 and adding molten machining material onto the workpiece 3, thereby forming an object 4. The additive manufacturing apparatus 100 has a function of measuring the height of the thus formed object 4 and controlling machining conditions for the next additive machining, on the basis of the measurement result. The configuration of the additive manufacturing apparatus 100 for implementing this function will be hereinafter described.

The machining laser 1 is a light source that emits machining light 30 for use in shaping machining, i.e.

creating the object 4 on the workpiece 3. The machining laser 1 is a fiber laser device using a semiconductor laser, a CO₂ laser device, or the like. The wavelength of the machining light 30 emitted by the machining laser 1 is, for example, 1070 nm.

The machining head 2 includes a machining optical system and a light-receiving optical system. The machining optical system concentrates the machining light 30 emitted from the machining laser 1 and focuses the machining light 30 on a machining position on the workpiece 3. The light-receiving optical system is also referred to as a height sensor. In general, the machining light 30 is concentrated in a point shape at the machining position, and thus the machining position is hereinafter also referred to as a machining point. The machining laser 1 and the machining optical system define a machining unit. The method of measuring the height of the object 4 formed at the machining position is hereinafter discussed as a line section method that uses an optical system. However, the method of measuring the height of the object 4 may be, e.g., an optical method different from the line section method. The optical method is, for example, a spot-type triangulation method, or a confocal method.

The light-receiving optical system is located inside the machining head 2, and the machining optical system and the light-receiving optical system are integrated together. This achieves a reduction in the size of the additive manufacturing apparatus 100. However, the present embodiment is not limited to this example. There is no restriction on how the machining head 2 and the height sensor are integrated.

The workpiece 3 is also called a “work”. The workpiece 3 is placed on the drive stage 6 and fixed on the drive stage 6 with the fixture 5. The workpiece 3 serves as a base on which the object 4 is formed, and the surface of the workpiece 3 is also referred to as the surface to be machined. Here, the workpiece 3 is a base plate, but may be an object having a three-dimensional shape.

As the drive stage 6 is driven, the position of the workpiece 3 relative to the machining head 2 changes, such that the machining point moves on the workpiece 3. That is, the machining point on the workpiece 3 runs. To have the machining point run means that the machining point moves along a predetermined path, specifically, in a predetermined trajectory. Note that the movement of the machining point involves movement in a direction orthogonal to the height direction of the object 4. Specifically, the position of the machining point before the movement and the position of the machining point after the movement are projected at different positions on the plane orthogonal to the height direction.

The additive manufacturing apparatus 100 moves the machining point, i.e., the machining position, on the workpiece 3, and performs additive machining by depositing, on the machining point, the machining material 7 melted at a predetermined machining position. In other words, the additive manufacturing apparatus 100 performs additive machining by depositing the melted machining material 7 at the machining point that moves on the workpiece 3. More specifically, the additive manufacturing apparatus 100 drives the drive stage 6 to move candidate points for the machining position on the workpiece 3. At least one of the candidate points on the movement path is a machining point on which the machining material 7 is deposited.

At the machining point, the additive manufacturing apparatus 100 melts the machining material 7 supplied for additive machining with the machining light 30. The machining material 7 is metal wire, metal powder, or the like. In the present embodiment, the machining material 7 is hereinafter discussed as metal wire. The metal wire is supplied from the machining material supply unit 10 to the machining point. For example, the machining material supply unit 10 rotates the wire spool with the metal wire wound therearound as the rotary motor is driven, thereby feeding the metal wire to the machining point. The machining material supply unit 10 can also rotate the motor in the reverse direction to thereby pull out the metal wire supplied to the machining point. The machining material supply unit 10 is installed integrally with the machining head 2 and is driven together with the machining head 2 by the drive stage 6. Note that the method of feeding metal wire is not limited to the above example.

The additive manufacturing apparatus 100 repeats running the machining point to stack beads of the melted and solidified machining material 7, thereby forming the object 4 on the workpiece 3. In other words, the additive manufacturing apparatus 100 repeats the additive machining to generate the object 4. The bead is a solidified form of the melted machining material 7, and make up the object 4. In the initial stage of additive machining, the additive manufacturing apparatus 100 deposits the melted machining material 7 on the workpiece 3. In repeated additive machining, the additive manufacturing apparatus 100 deposits the melted machining material 7 on the object 4 already formed by the time of that deposition. In the first embodiment, the additive manufacturing apparatus 100 forms a bead having a ball shape. A bead having a ball shape is hereinafter referred to as a ball bead. A ball bead is a ball-shaped metal that is the machining material 7 melted and then solidified.

The drive stage 6 can run in three axes of X, Y, and Z. Note that the Z direction is the height direction of the object 4. In addition, the X direction is a direction orthogonal to the Z direction. Further, the Y direction is the direction orthogonal to both the X direction and the Z direction. The drive stage 6 can translate in the direction of any one of the X, Y, and Z axes. The drive stage 6 may be a five-axis stage that can also rotate in the XY plane and the YZ plane. The use of the rotary stage enables the posture or position of the workpiece 3 to be changed. By rotating the drive stage 6, the additive manufacturing apparatus 100 can move the irradiation position of the machining light 30 with respect to the workpiece 3. This can create complicated shapes including a tapered shape. The drive stage 6 described herein is configured to run in five axes, but the machining head 2 may be run instead.

The gas nozzle 9 ejects, toward the workpiece 3, a shield gas for preventing oxidation of the object 4 and cooling the ball beads. In the present embodiment, the shield gas is an inert gas. The gas nozzle 9 is attached to the lower part of the machining head 2 and is disposed above the machining point. In the present embodiment, the gas nozzle 9 is disposed coaxially with the machining light 30, but the gas may be ejected toward the machining point in a direction oblique to the Z axis.

The measurement illumination unit 8 emits illumination light 40 for measurement to a measurement position on the workpiece 3 in order to measure the height of the object 4 formed on the workpiece 3 by the additive manufacturing apparatus 100. The measurement position is the same as the position of the machining point. The illumination light 40 is reflected at the measurement position. The light-receiving optical system of the machining head 2 is located at a position where the light-receiving optical system can receive the illumination light 40 reflected at the measurement position. In addition, the light-receiving optical system is located such that the optical axis of the light-receiving optical system has an angle with respect to the optical axis of the illumination light 40. A laser providing a wavelength different from that of the machining light 30 is desirably used as the light source of the measurement illumination unit 8. The illumination light 40 is a line beam that is linear light. Note that the illumination light 40 that is used for measuring the height of the object 4 need not necessarily be a line beam. The illumination light 40 may be a spot beam that is light concentrated in a point shape. The use of the spot beam enables the measurement of the height of the object 4 at the illuminated point on the workpiece 3. The use of the line beam enables the measurement of the height of the object 4 in the illuminated range on the workpiece 3.

The calculation unit 50 calculates the height of the object 4 at machining position, i.e., the position irradiated with the illumination light 40. The height of the object 4 is measured after the movement of the machining position and before the execution of additive machining at that post-movement machining position. Specifically, the calculation unit 50 calculates the height of the object 4 at the machining position, using the principle of triangulation on the basis of the light-receiving position of the reflected illumination light 40. The term “light-receiving position” as used herein is the position of the illumination light 40 on the light-receiving element included in the light-receiving optical system. The height of the object 4 is the Z-directional position of the upper surface of the object 4. The measurement illumination unit 8, the light-receiving optical system, and the calculation unit 50 define a height measurement unit. The measurement illumination unit 8 and the light-receiving optical system define the height sensor. The height measurement unit measures the height at the measurement position, namely, the machining position, of the object 4 formed on the workpiece 3.

The control unit 51 uses the height calculated by the calculation unit 50 to control machining conditions such as driving conditions for the machining laser 1, driving conditions for the machining material supply unit 10 that supplies metal wire as the machining material 7, and the number of ball beads to be stacked. The driving conditions for the machining material supply unit 10 include the height at which metal wire is supplied.

Next, a hardware configuration of the calculation unit 50 and the control unit 51 according to the first embodiment of the present invention will be described. The calculation unit 50 and the control unit 51 are implemented by processing circuitry. The processing circuitry may be implemented by dedicated hardware or may be a control circuit using a central processing unit (CPU).

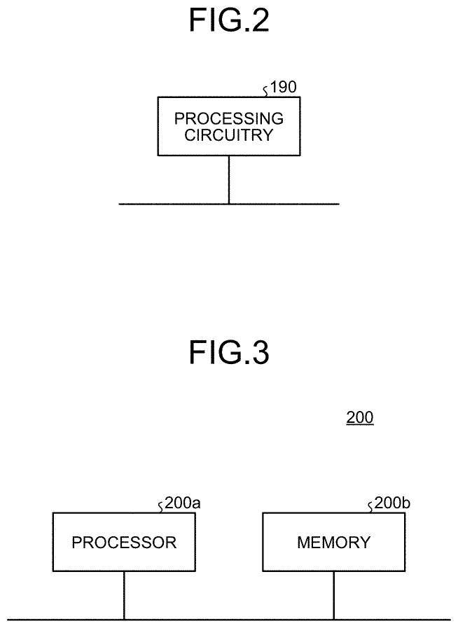

In a case where the above processing circuitry is implemented by dedicated hardware, the processing circuitry is implemented by processing circuitry 190 illustrated in FIG. 2. FIG. 2 is a diagram illustrating dedicated hardware for implementing the functions of the calculation unit 50 and the control unit 51 illustrated in FIG. 1. The processing circuitry 190 is a single circuit, a composite circuit, a programmed processor, a parallel programmed processor, an application specific integrated circuit (ASIC), a field programmable gate array (FPGA), or a combination thereof.

In a case where the above processing circuitry is implemented by a control circuit using a CPU, this control circuit is, for example, a control circuit 200 having the configuration illustrated in FIG. 3. FIG. 3 is a diagram illustrating a configuration of the control circuit 200 for implementing the functions of the calculation unit 50 and the control unit 51 illustrated in FIG. 1. As illustrated in FIG. 3, the control circuit 200 includes a processor 200a and a memory 200b. The processor 200a is a CPU, and is also called a central processing device, a processing device, an arithmetic device, a microprocessor, a microcomputer, a digital signal processor (DSP), or the like. Examples of the memory 200b include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

In a case where the above processing circuitry is implemented by the control circuit 200, the processor 200a reads and executes the program corresponding to the process of each component stored in the memory 200b, thereby implementing the processing circuitry. The memory 200b is also used as a temporary memory for each process executed by the processor 200a.

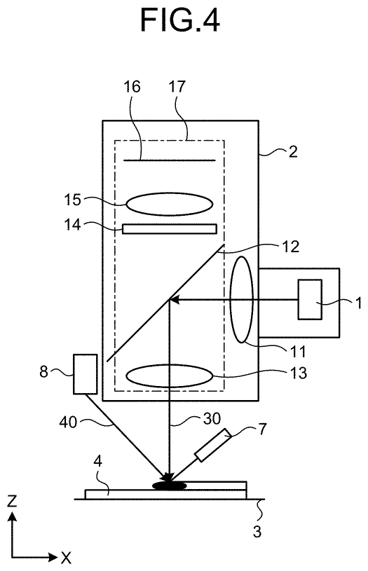

FIG. 4 is a diagram illustrating the internal configuration of the machining head 2 illustrated in FIG. 1. FIG. 4 depicts the XZ-cross-sectional configuration of the additive manufacturing apparatus 100. The machining head 2 includes a light-projecting lens 11, a beam splitter 12, an objective lens 13, a bandpass filter 14, a condenser lens 15, and a light receiver 16.

The light-projecting lens 11 transmits, toward the beam splitter 12, the machining light 30 emitted from the machining laser 1. The beam splitter 12 reflects, toward the workpiece 3, the machining light 30 incident from the light-projecting lens 11. The objective lens 13 concentrates the machining light 30 incident via the light-projecting lens 11 and the beam splitter 12, and focuses the machining light 30 on the machining position on the workpiece 3. The light-projecting lens 11, the beam splitter 12, and the objective lens 13 define the machining optical system.

For example, the focal length of the light-projecting lens 11 is 200 mm, and the focal length of the objective lens 13 is 460 mm. The surface of the beam splitter 12 is coated to increase the reflectance at the wavelength of the machining light 30 emitted from the machining laser 1 and transmit light having a wavelength shorter than the wavelength of the machining light 30.

The additive manufacturing apparatus 100 drives the drive stage 6 to run the workpiece 3, such that the machining point runs and stops at a predetermined position, whereupon the additive manufacturing apparatus 100 supplies the machining material 7 to the machining point. The irradiation of the machining point with the machining light 30 causes the machining material 7 supplied to the machining point to be melted and then solidified, and a ball bead is formed on the workpiece 3. The formed ball bead is a part of the object 4. Every time the machining point runs, a new ball bead is deposited on the workpiece 3 serving as a base or on the formed object 4. Consequently, a new part of the object 4 is formed. This operation is repeated, whereby the machining material 7 is deposited in layers into the desired shape of the object 4.

The measurement illumination unit 8 emits the illumination light 40 to the measurement position. The illumination light 40 reflected at the measurement position enters the bandpass filter 14 via the objective lens 13 and the beam splitter 12. The beam splitter 12 transmits the illumination light 40 from the machining point in the direction to the bandpass filter 14. The bandpass filter 14 selectively transmits light having the wavelength of the illumination light 40, and blocks light having a wavelength other than the wavelength of the illumination light 40. The bandpass filter 14 removes light of an unnecessary wavelength such as machining light, thermal radiation light, and ambient light, and transmits the illumination light 40 toward the condenser lens 15. The condenser lens 15 concentrates the illumination light 40 and focuses the illumination light 40 on the light receiver 16. The light receiver 16 is an area camera or the like equipped with a light-receiving element such as a complementary metal oxide semiconductor (CMOS) image sensor. Instead of the CMOS sensor, the light receiver 16 may include any light-receiving element in which pixels are two-dimensionally arranged.

The objective lens 13 and the condenser lens 15 are collectively referred to as the light-receiving optical system. The light-receiving optical system described herein includes two lenses, but three or more lenses may be used. The light-receiving optical system may be configured in any manner that enables the illumination light 40 to be focused on the light receiver 16. The light-receiving optical system and the light-receiving element are collectively referred to as a light-receiving unit 17.

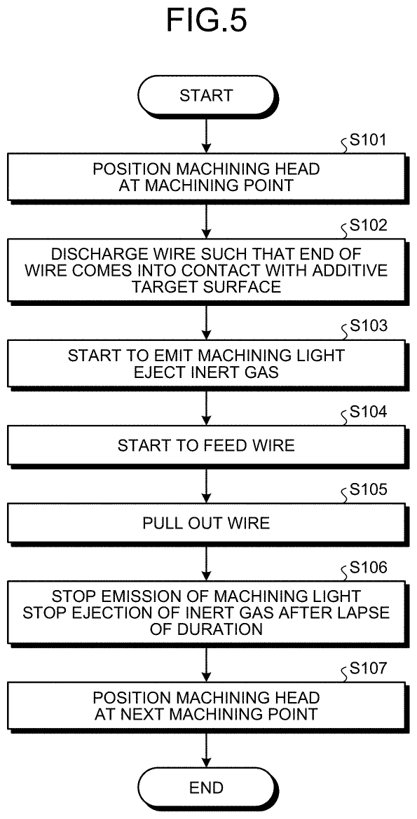

FIG. 5 is a flowchart for explaining an operation in which the additive manufacturing apparatus 100 illustrated in FIG. 1 forms a ball bead.

First, the additive manufacturing apparatus 100 drives the drive stage 6 to thereby position the machining head 2 at the machining point which is a predetermined position above the machining area on the additive target surface of the workpiece 3 (step S101). The term “additive target surface” as used herein, which is the surface of the workpiece 3 on which ball beads are stacked, is the upper surface of the workpiece 3 placed on the stage. In the case of performing additive machining on the already formed object 4, the additive target surface is the surface of the object 4.

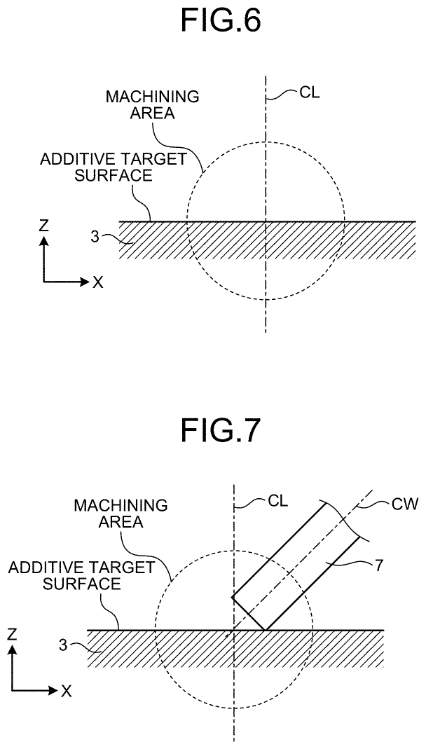

FIG. 6 is a schematic cross-sectional diagram illustrating the machining area of the additive manufacturing apparatus 100 illustrated in FIG. 1. As illustrated in FIG. 6, the machining point is a point at which a central axis CL of the machining light 30 and the additive target surface intersect. In the present embodiment, the machining point is the center position of the machining area on the additive target surface.

Reference is made back to FIG. 5. The additive manufacturing apparatus 100 discharges metal wire as the machining material 7 such that the end of the wire comes into contact with the additive target surface (step S102).

FIG. 7 is a schematic cross-sectional diagram in which the wire discharged to the machining area of the additive manufacturing apparatus 100 illustrated in FIG. 1 is in contact with the additive target surface. As illustrated in FIG. 7, the additive manufacturing apparatus 100 discharges the machining material 7 that is wire, in an oblique direction from above the machining area to bring the end of the machining material 7 into contact with the additive target surface. To discharge the wire means that the additive manufacturing apparatus 100 controls the machining material supply unit 10 to cause the wire to advance from the wire nozzle to be supplied to the machining point. Before irradiation of the machining area with the machining light 30, the machining material 7 is in contact with the additive target surface. Thus, molten wire is stably welded to the additive target surface, and it is possible to prevent molten wire from failing to be welded to the additive target surface or from being welded at a position displaced from the desired position.

It is preferable that a central axis CW of the wire discharged from the wire nozzle and brought into contact with the additive target surface and the central axis CL of the machining light 30 emitted onto the machining area intersect at the surface of the additive target surface. Alternatively, it is preferable that the central axis CW of the wire and the surface of the additive target surface intersect within the beam radius of the machining light 30 between the wire nozzle and the central axis CL of the machining light 30 emitted onto the machining area. Positioning the wire in that manner enables forming a ball bead on the additive target surface such that the formed ball bead has its center at the intersection of the central axis CW of the wire and the central axis CL of the machining light 30 emitted onto the machining area.

Reference is made back to FIG. 5. Once the preparation of the machining material 7 is completed, the additive manufacturing apparatus 100 starts to emit the machining light 30 and ejects inert gas from the gas nozzle 9 (step S103).

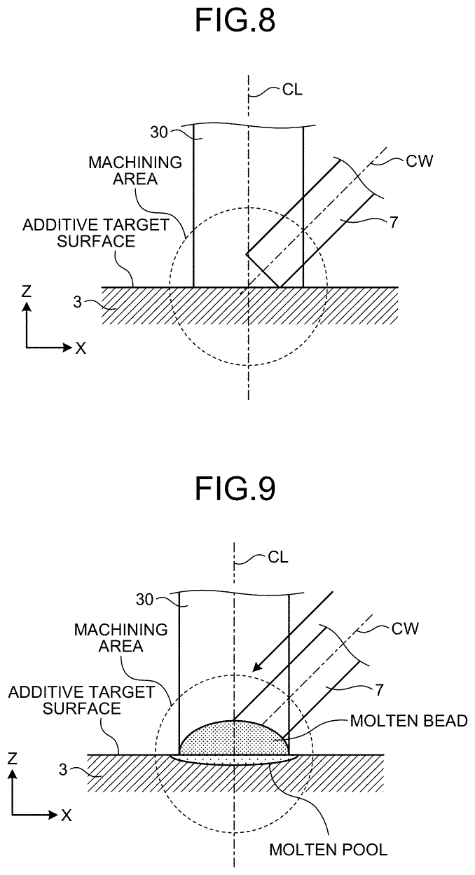

FIG. 8 is a schematic cross-sectional diagram in which the machining area of the additive manufacturing apparatus 100 illustrated in FIG. 1 is irradiated with the machining light 30. As illustrated in FIG. 8, the machining light 30 is emitted toward the machining area of the additive target surface. At this time, the machining light 30 is emitted to the wire that is the machining material 7 located in the machining area. In conjunction with the emission of the machining light 30, the ejection of inert gas from the gas nozzle 9 to the machining area starts. It is preferable that the ejection of inert gas start before the surface to be machined is irradiated with the machining light 30. It is also preferable that inert gas be ejected for a predetermined fixed time. Ejecting inert gas for the fixed time before the emission of the machining light 30 enables active gas such as oxygen remaining in the gas nozzle 9 to be removed from the gas nozzle 9.

Reference is made back to FIG. 5. The additive manufacturing apparatus 100 starts to feed the wire that is the machining material 7 (step S104).

FIG. 9 is a schematic cross-sectional diagram in which the supply of wire to the machining area of the additive manufacturing apparatus 100 illustrated in FIG. 1 is started. The additive manufacturing apparatus 100 controls the wire nozzle of the machining material supply unit 10 such that the wire is discharged in the direction of the arrow in FIG. 9 toward the machining area of the additive target surface. As a result, the wire located in the machining area in advance and the wire supplied to the machining area after the start of the emission of the machining light 30 are melted, and the molten wire is welded to the additive target surface. In the machining area, the additive target surface defined by the surface of the workpiece 3 or the surface of the object 4 is melted into a molten pool upon the emission of the machining light 30. Then, in the machining area, molten wire is welded to the molten pool. As a result, a deposit, or a molten bead, is formed in the machining area. After that, the supply of wire to the machining area continues for a predetermined supply time.

The supply speed of wire can be adjusted with the rotation speed of the rotary motor of the machining material supply unit 10. The supply speed of wire is limited by the output of the machining light 30. That is, there is a correlation between the supply speed of wire and the output of the machining light 30 for achieving proper welding of molten wire to the machining area. It is possible to increase the creation speed of a ball bead by increasing the output of the machining light 30.

If the supply speed of wire is too fast relative to the output of the machining light 30, the wire remains not melted. If the supply speed of wire is too slow relative to the output of the machining light 30, the wire is overheated, and thus molten wire falls from the wire in the form of droplets without being welded into a desired shape.

Changing the supply time of wire and the emission time of the machining light 30 can adjust the size of a ball bead. The longer the supply time of wire and the emission time of the machining light 30, the larger the diameter of the resultant ball bead. On the other hand, the shorter the supply time of wire and the emission time of the machining light 30, the smaller the diameter of the resultant ball bead.

Reference is made back to FIG. 5. Once the additive machining at the first machining position is completed, the additive manufacturing apparatus 100 pulls out the wire that is the machining material 7, from the machining area (step S105).

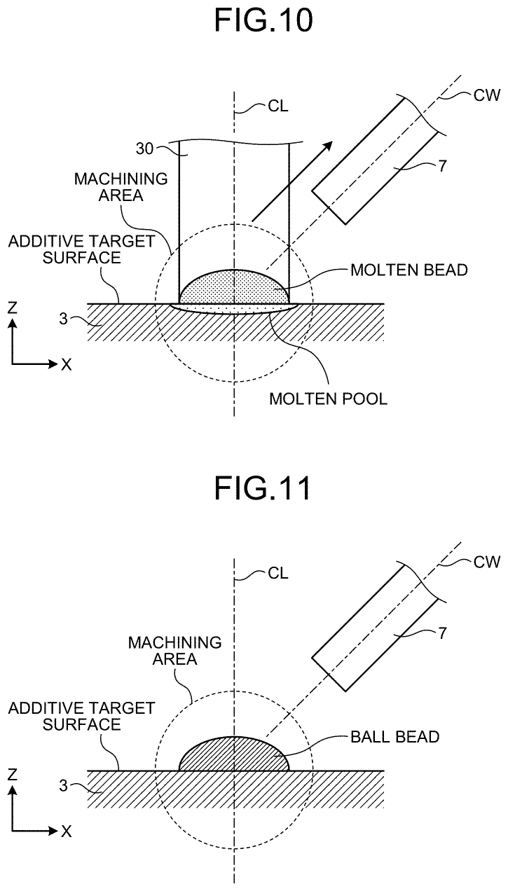

FIG. 10 is a schematic cross-sectional diagram in which the wire is pulled out from the machining area of the additive manufacturing apparatus 100 illustrated in FIG. 1. Once the additive machining at the first machining position is completed, the additive manufacturing apparatus 100 pulls out the wire that is the machining material 7, from the machining area in the direction indicated by the arrow in FIG. 10. At this time, the molten pool formed on the workpiece 3 and the molten bead are integrated together, and pulling out the wire separates the wire from the molten bead.

Reference is made back to FIG. 5. After the wire is pulled out, the additive manufacturing apparatus 100 stops the emission of the machining light 30. In addition, the additive manufacturing apparatus 100 continues ejecting inert gas from the gas nozzle 9 after stopping the emission of the machining light 30. Then, after a lapse of the duration, the additive manufacturing apparatus 100 stops the ejection of inert gas from the gas nozzle 9 (step S106).

FIG. 11 is a schematic cross-sectional diagram in which the irradiation of the machining area of the additive manufacturing apparatus 100 illustrated in FIG. 1 with the machining light 30 is stopped. After the irradiation of the machining area with the machining light 30 stops, the ejection of inert gas continues for the duration. After a lapse of the duration, the ejection of inert gas stops, and then the molten bead is solidified to form a ball bead on the additive target surface.

The duration is determined on the basis of the time from when the machining light 30 stops to when the temperature of the molten bead welded to the machining area drops to a predetermined temperature. The time taken for the temperature of the molten bead to drop to a predetermined temperature depends on various conditions such as the material of the wire and the size of the ball bead. The duration based on these conditions is stored in advance in the control unit 51. The temperature of the molten bead drops to a predetermined temperature after a lapse of the duration, and the formation of the ball bead is completed.

Reference is made back to FIG. 5. Once the additive machining at the first machining position is completed and the ball bead is formed, the additive manufacturing apparatus 100 positions the machining head 2 at the next machining point (step S107). Specifically, the additive manufacturing apparatus 100 controls the drive stage 6 to change the relative position between the workpiece 3 and the machining head 2, thereby positioning the machining head 2 above the second machining position that is the next machining point.

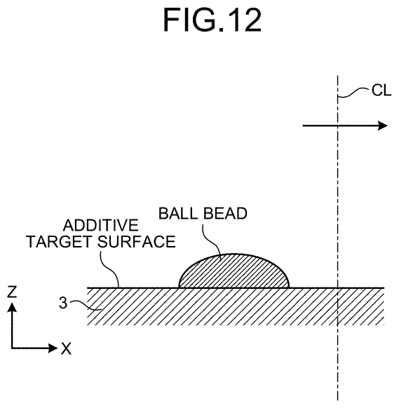

FIG. 12 is a schematic cross-sectional diagram in which the machining head 2 of the additive manufacturing apparatus 100 illustrated in FIG. 1 moves to the next machining point. Note that FIGS. 6 to 12 illustrate the state of a peripheral region of the machining area on the additive target surface. In FIGS. 8 to 11, inert gas is not illustrated.

The arrow in FIG. 12 indicates the direction of movement of the machining head 2 relative to the workpiece 3, and the central axis CL of the machining light 30 moves in the direction of the arrow relative to the workpiece 3 along with the movement of the position of the machining head 2 relative to the workpiece 3. The central axis CL is moved to the second machining position, which is the next machining point.

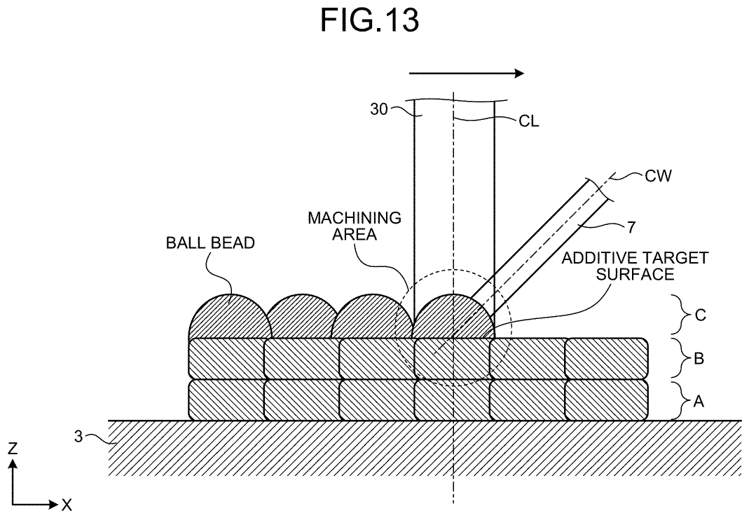

FIG. 13 is a schematic cross-sectional diagram for explaining a method of creating the object 4 with the additive manufacturing apparatus 100 illustrated in FIG. 1. By repeating the steps illustrated in FIG. 5, it is possible to form a layer of ball beads that make up the object 4 on the additive target surface. The layer of ball beads directly formed on the surface of the workpiece 3 is referred to as a first layer A. In addition, the layer of ball beads formed on the first layer A is referred to as a second layer B. The layer of ball beads formed on the second layer B is referred to as a third layer C. By stacking multiple layers of ball beads, the additive manufacturing apparatus 100 can form the object 4 having a desired shape on the workpiece 3. The additive manufacturing apparatus 100 changes the position of the drive stage 6 in the Z-axis direction by a certain amount every time the additive machining of each layer is completed. It is preferable that the amount of change in the Z-axis direction be equal to the height of the ball bead that is to be formed.

The above-mentioned steps need not necessarily be executed in the above-described order. The present embodiment is not limited to the above-described example, in which when the machining position is moved and a ball bead is created, the step of positioning the machining head 2 above the machining point is separated from the step of discharging wire. In order to shorten the machining time, the movement to the next machining point may be conducted during the discharge of the wire. This enables the wire to be already in contact with the additive target surface by the time of the arrival at the next machining point, which results in a reduction in machining time.

It is preferable that the object 4 be created with a designed height, but the height of the ball beads to be added may vary depending on additive machining conditions, resulting in the object 4 with a height different from the designed one. Examples of additive machining conditions include the shape of the additive target surface, the wire feeding position, the situation of wire pullout, and the like. If the height of the wire relative to the additive target surface is not within the optimum range, the ball bead cannot be created with high accuracy. For example, if the position of the wire is too high relative to the additive target surface, molten wire does not sufficiently adhere to the additive target surface. If the position of the wire is too low relative to the additive target surface, the wire cannot be sufficiently melted and can leave a melting residue.

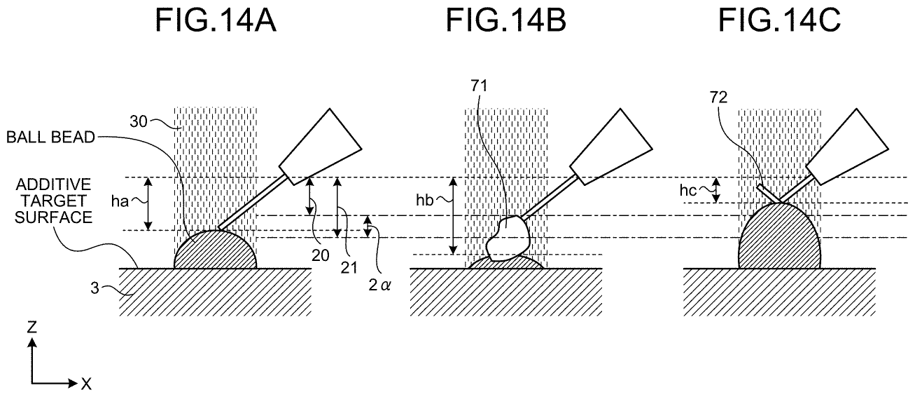

FIG. 14 is a diagram illustrating the height of the wire relative to the object 4 that is formed by the additive manufacturing apparatus 100 illustrated in FIG. 1. The height of the wire means the height of the wire supply port relative to the additive target surface such as the upper surface of the workpiece 3 or the upper surface of a ball bead. The height of the wire may also be the height of the wire end because the height of the wire end can be calculated with the set amount of emission from the wire supply port. An appropriate range of wire heights depends on the height of the formed object 4.

As illustrated in FIG. 14, failure in the supply of wire at a height corresponding to the formed object 4 causes a defect in the machining result. For example, suppose that an appropriate range of wire heights corresponding to the formed object 4 illustrated in FIG. 14 is ha±α. In FIG. 14(a), the height of the wire is in the middle of the range of ha±α. In other words, the height of the wire in FIG. 14(a) is ha. A lower limit 20 of wire height is ha-a, and an upper limit 21 of wire height is ha+α. In FIG. 14(a), because the height of the wire is ha, which is within the range of ha±α, no defect occurs in the machining result.

In FIG. 14(b), however, the height of the formed ball bead serving as the surface to be machined is less than the design value, and the wire has a height hb that satisfies hb>ha+α, which is out of the range of ha±α. In this case, the wire melted by being irradiated with the machining light 30 does not sufficiently adhere to the formed object 4, which causes a droplet 71 that results in unevenness in the resultant object 4.

In FIG. 14(c), the height of the formed ball bead serving as the surface to be machined is greater than the design value, and the wire has a height he that satisfies hc<ha−α, which is out of the range of ha±α. In this case, the wire is pressed too much in the direction to the formed object 4; therefore, the wire is not completely melted even by being irradiated with the machining light 30, and leaves a melting residue 72 of wire. As a result, the resultant object 4 contains the non-melted wire. Thus, to maintain the height of the wire at an appropriate value in accordance with the state of the formed object 4 is essential for highly accurate machining.

In the additive machining for providing the first layer defined by the object 4 deposited on the upper surface of the workpiece 3, the height of the wire only needs to be maintained constant if the upper surface of the workpiece 3 is flat. In the second and subsequent layers, it is necessary to perform additive machining on the previous layer of the formed object 4. If the height of the formed object 4 is the design value, the height of the wire only needs to be controlled on the basis of the design value. However, the height of the formed object 4 is not always the design value. In this case, increasing the height of the wire by the design height of one layer may practically result in the height of the wire being out of the appropriate range relative to a portion of the formed object 4 as this portion of the object 4 has a height different from the design value. Even when the height of the wire for forming the second layer is within the allowable range ha±α, i.e., within the allowable error range, the error can be accumulated n(n≥2) times through multiple repetitions of additive machining to form a n-th layer. As a result, in this case, the height of the wire may not be within the allowable error range. In view of this, the present embodiment measures the height of the practically machined object 4, and controls machining conditions on the basis of the measurement result.

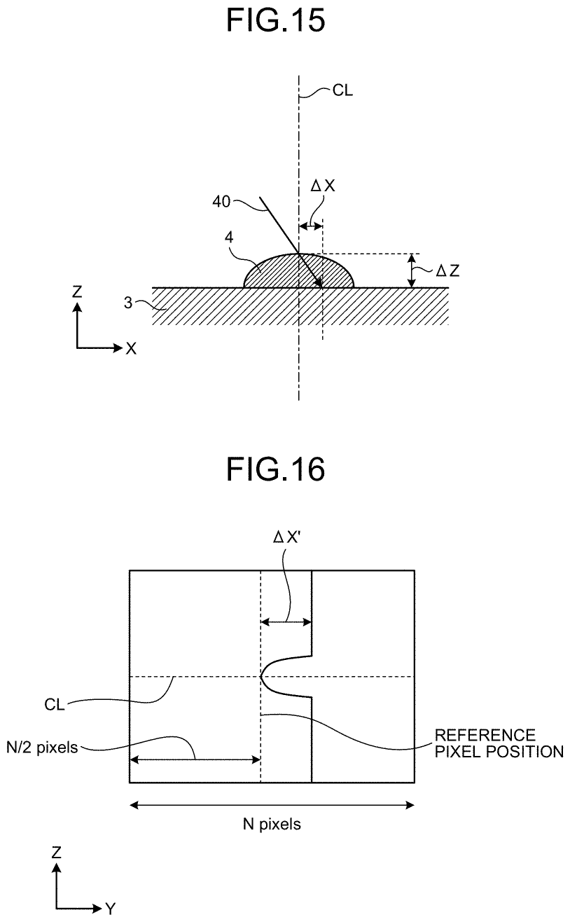

Next, a method of measuring the height of the formed object 4 with the height measurement unit will be described. FIG. 15 is a diagram schematically illustrating an XZ cross-section of the object 4 on which the illumination light 40 is projected from the measurement illumination unit 8 illustrated in FIG. 1. The measurement illumination unit 8 is attached to a side surface of the machining head 2 and emits the illumination light 40 which is a line beam toward the measurement position on the workpiece 3 or the formed object 4. The measurement position is determined in consideration of, for example, the direction of supply of the machining material 7. For example, the measurement position may be on the side opposite to the direction of supply of the machining material 7 with the machining point therebetween, in which case the measurement position is easily illuminated without being blocked by the machining material 7. The illumination light 40 is formed using a cylindrical lens or the like so as to form a beam extending in the Y direction, which is perpendicular to the direction in which the wire is supplied and parallel to the upper surface of the drive stage 6. Thus, the illumination light 40 is linearly emitted to the formed object 4. The illumination light 40 emitted to the measurement position is reflected at the measurement position, enters the objective lens 13, passes through the beam splitter 12 and the bandpass filter 14, and is focused on the light receiver 16 by the condenser lens 15.

Now consider a case where the focal point of the light-receiving optical system of the height sensor is at the height of the machining position of the ball bead. The height of the object 4 relative to the upper surface of the workpiece 3 is denoted by ΔZ, and the irradiation angle of the illumination light 40 is denoted by θ. In this case, a difference ΔX between the illumination position of the illumination light 40 on the upper surface of the workpiece 3 and the irradiation position of the illumination light 40 on the object 4 is expressed as ΔX=ΔZ/tan θ.

FIG. 16 is a diagram illustrating the light-receiving position on the light-receiving element with the object 4 irradiated with the illumination light 40 by the additive manufacturing apparatus 100 illustrated in FIG. 1. The projection position of the illumination light 40 corresponding to the focal point of the light-receiving optical system is defined as the pixel center in the X direction, and is referred to as a reference pixel position. The projection position of the illumination light 40 in the X direction at a position corresponding to the machining position in the Y direction is defined as the ball bead height at the machining position. The machining position CL is set to be the center in the Y direction on the light-receiving element, but need not be the center. A value calculated from one Y-directional pixel corresponding to the machining position CL can be used. Alternatively, an average of a plurality of pixels may be used.

The reference pixel position does not need to be the focal point of the light-receiving optical system, and can be freely set. Because the illumination light 40 is projected at the machining position on the ball bead which is the focal point of the light-receiving optical system, the focal point of the light-receiving optical system is the reference pixel position on the light-receiving element.

The height of the object 4 is different from the height of the surface of the workpiece 3; therefore, the irradiation position of the illumination light 40 is projected with a displacement of ΔX′. Using a magnification M of the light-receiving optical system, ΔX′=M×ΔX holds true. Assuming that the size of one pixel of the image sensor is P, a height displacement amount ΔZ′ per pixel is expressed as ΔZ′=P×tan θ/M. The calculation unit 50 can thus calculate the height of the ball bead from the upper surface of the workpiece 3 by converting the displacement of the projection position of the illumination light 40 between the machining position of the ball bead on the light-receiving element and the surface of the workpiece 3, using the principle of triangulation.

In addition, in the case of the additive machining of a plurality of layers, the drive stage 6 is raised by a certain amount in the Z direction every time one layer is deposited; therefore, the height of the machining head 2 and the height sensor relative to the upper surface of the workpiece 3 is raised. Thus, the focal position of the height sensor also rises as the drive stage 6 rises. Therefore, the Z-directional height that is the reference pixel position also increases. The calculation of the difference from the reference pixel position is repeated, and the height of the object 4 can become so high relative to the upper surface of the workpiece 3 that the light-receiving element fails to receive the reflected light of the illumination light 40 from the upper surface of the workpiece 3. Even in such a case, it is possible to calculate the height of the object 4 from the integral of the cumulative amount of Z-axial rise and the difference between the reference pixel position and the irradiation position of the illumination light 40 reflected from the upper surface of the object 4, in the field of view on the light-receiving element. Assuming that the number of pixels of the light-receiving element in the X direction is N pixels, a range Zr in which the height of the object 4 is measurable is expressed as Zr=N×tan θ/M. It is noted that it is not necessary to use every pixel in the X direction of the light-receiving element as the height measurable range. Rather, only the center of the field of view may be used when the performance of the view field end is low due to, for example, the influence of aberration.

The calculation unit 50 calculates the irradiation position of the illumination light 40 which is a line beam, on the basis of the centroid position of the projection pattern of the illumination light 40 in the X direction. The calculation unit 50 calculates an output in the X direction for each Y-directional pixel, and calculates the centroid position from the cross-sectional intensity distribution of the illumination light 40. The method of calculating the irradiation position of the illumination light 40 is not limited to the use of the centroid position. For example, the calculation unit 50 may calculate the irradiation position of the illumination light 40 on the basis of the peak position of the light amount. The irradiation width of the illumination light 40, that is, the length of the line beam, needs to be large enough to allow calculation of the irradiation position. For example, in the case of using the centroid position, too narrow an irradiation width does not allow calculation of the centroid position, and too wide an irradiation width is liable to cause an error due to the influence of change in beam intensity pattern. Thus, the irradiation width is desirably about 5 to 10 pixels. In addition, the irradiation width of the illumination light 40 should be sufficiently longer than the width of the object 4. If it is not necessary to perform centroid calculation for all the Y-directional pixels of the projected line beam to calculate the height, for example, if the vicinity of the machining position CL is sufficient, then only the region in the vicinity of the machining position CL may be used.

As discussed above, calculating the luminance centroid position in the X direction for each Y-directional pixel of the image, and converting the calculation result into height make it possible to measure the cross-sectional distribution of the height of the object 4 in the width direction of the object 4. In a case where the illumination light 40 that is used to measure the height of the object 4 is a spot beam, the cross-sectional distribution of the height of the object 4 cannot be measured; however, appropriately selecting the size of the spot enables measurement with less error.

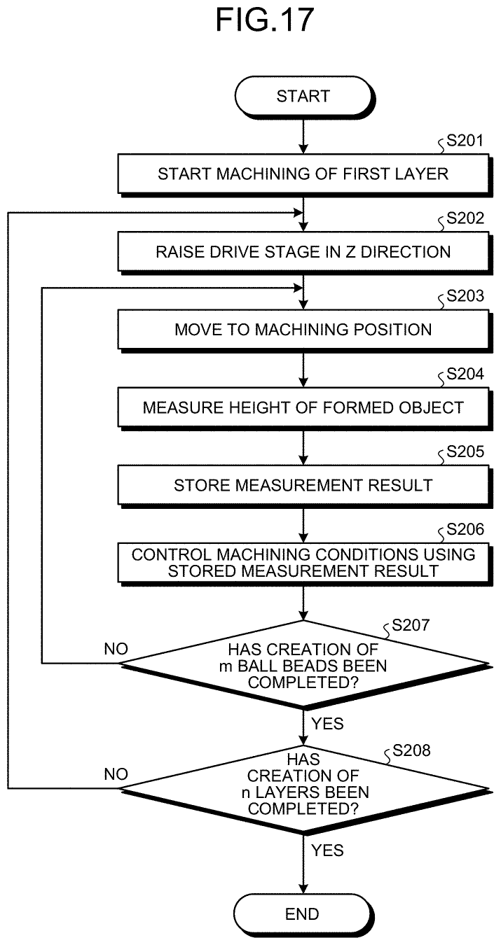

Next, a procedure for additive process using the measurement result of the height of the formed object 4 will be described. FIG. 17 is a flowchart for explaining a procedure for performing additive process, using the measurement result of the height of the object 4 formed by the additive manufacturing apparatus 100 illustrated in FIG. 1.

The following exemplary case is based on the assumption that one layer consists of m ball beads and n layers of m ball beads are stacked. First, the additive machining of the first layer starts (step S201). In a case where the upper surface of the workpiece 3 is a flat base plate, there is no bead at the measurement position at the time of the additive machining of the first layer, and thus, it is not necessary to measure the height. In forming the first layer, however, height measurement may be performed for accurate additive machining, taking into consideration the stacking of ball beads on the object 4, or when the base plate is distorted, for example. The measurement of the height of the first layer is not performed in the process of FIG. 17. Note that the specific processing in step S201 is the one illustrated in FIG. 5.

Once all the additive machining of the first layer is completed, the additive manufacturing apparatus 100 raises the drive stage 6 in the Z direction so as to perform the additive machining of the second layer (step S202). The additive manufacturing apparatus 100 moves the drive stage 6 such that the machining head 2 arrives at the machining position where the first ball bead is to be produced (step S203).

The additive manufacturing apparatus 100 starts measuring, at the machining position, the height of the object 4 formed in the first layer (step S204). The additive manufacturing apparatus 100 stores the measurement result of the height of the formed object 4 (step S205). The measurement position is the machining position of the ball bead to be produced next.

The additive manufacturing apparatus 100 performs additive machining, during which the additive manufacturing apparatus 100 controls machining conditions, using the measurement result of the height of the object 4 stored in step S205 (step S206). The additive manufacturing apparatus 100 determines whether the creation of m ball beads has been completed in the current layer (step S207).

In response to determining that the creation of m ball beads has not been completed (step S207: No), the additive manufacturing apparatus 100 returns to step S203. In response to determining that the creation of m ball beads has been completed (step S207: Yes), the additive manufacturing apparatus 100 subsequently determines whether the creation of n layers has been completed (step S208). In response to determining that the creation of n layers has not been completed (step S208: No), the additive manufacturing apparatus 100 returns to step S202. In response to determining that the creation of n layers has been completed (step S208: Yes), the additive manufacturing apparatus 100 ends the additive machining. The additive manufacturing apparatus 100 repeats steps S201 to S208, so that the object 4 having a predetermined shape can be produced as the result of the additive machining.

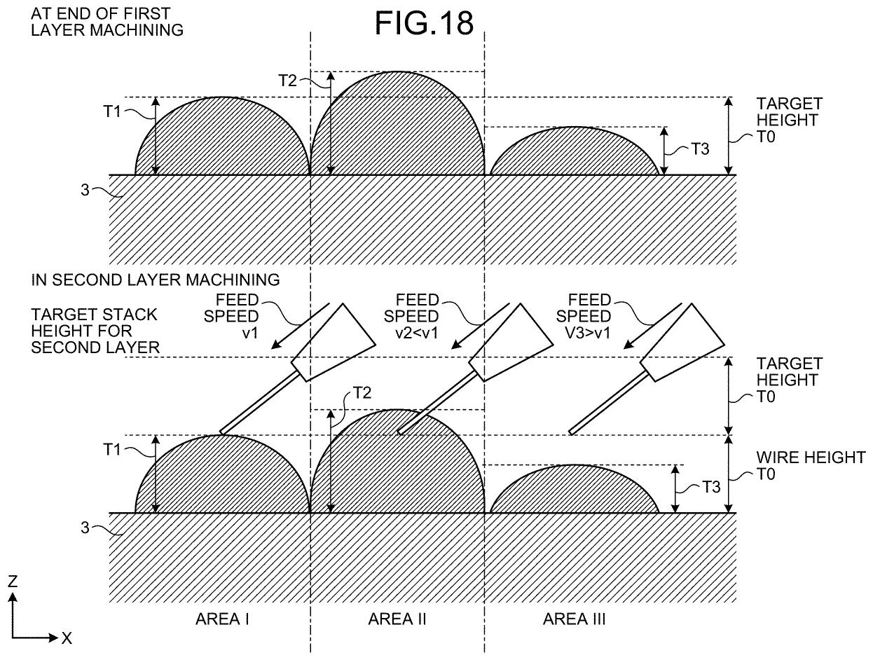

Next, details of the machining control will be described. FIG. 18 is a diagram illustrating a method of controlling the wire supply speed when the additive manufacturing apparatus 100 illustrated in FIG. 1 machines the second layer. Area I represents the case where a practical height T1 of the object 4 formed in the first layer is equal to a target height T0 of the object 4. The target height T0 is a preset height for a deposit to be newly deposited on the object 4. In area II, a practical height T2 of the object 4 formed in the first layer is greater than the target height T0. In area III, a practical height T3 of the object 4 formed in the first layer is less than the target height T0. For the sake of simplicity, the wire height which is the height of the wire end for producing the object 4 having a target stack height is set to the target height T0. However, in practice, the wire height for producing the object 4 having a target stack height may be different from the target height T0.

In the case of machining the second layer in area I, the height T1, which is the measurement result of the first layer, is the same as the target height T0; therefore, the control unit 51 does not change any machining conditions. In the case of machining the second layer in area II, the height T2, which is the measurement result of the first layer, is greater than the target height T0. Even when the wire height relative to the additive target surface in forming the first layer can be within the allowable range ha±α, the wire height deviates from the allowable range through continuous additive machining. Thus, in order to produce the second layer with a stack height of 2×T0, it is necessary to set the stack height of the second layer to 2×T0−T2.

Examples of machining conditions for changing the stack height include the wire feed speed, namely the wire supply amount, the output of the machining laser 1, the emission time of the machining light 30 from the machining laser 1, the number of ball beads to be stacked, the feed amount of the drive stage 6 in the Z direction, for example. In this exemplary case, the feed speed of wire is controlled.

Controlling the feed speed of wire makes it possible to control the amount of supply of wire to the machining point during the emission of the machining light 30. Let v1 represent the wire feed speed for producing a deposit having the target height T0 in area I. In area II, the stack height needs to be less than in area I. The control unit 51 thus uses a wire feed speed v2 lower than v1 to reduce the supply amount of wire so that the object 4 made up of the first and second layers has a height of 2×T0 at the end of the second layer machining.

In area III, the height T3, which is the measurement result, is less than the target height T0; therefore, it is necessary to set the stack height of the second layer to 2×T0−T3. The control unit 51 thus uses a wire feed speed v3 higher than v1 to increase the supply amount of wire so that the object 4 made up of the first and second layers has a height of 2×T0 at the end of the second layer machining. To sum up, the control unit 51 controls machining conditions on the basis of the difference between the measurement result and the target height T0, thereby controlling the stack height for the next additive machining. The control value for the wire feed speed only needs to be obtained by calculating and holding in advance the relationship between the wire feed speed and the height of the bead to be deposited. In a case where a plurality of layers are stacked, the control value may be dynamically changed during additive machining, using the result of stacking based on the measured bead height of the previous layer.

In the above description, the feed speed of wire is changed for changing the stack height for additive machining, but a parameter different from the feed speed may be changed. Alternatively, machining conditions may be controlled changing multiple types of parameters. For example, to reduce a stack height, the machining laser 1 can reduce its output and emit the machining light 30 for a shortened time. To increase the stack height, in contrast, the machining laser 1 can increase its output and emit the machining light 30 for a lengthened time.

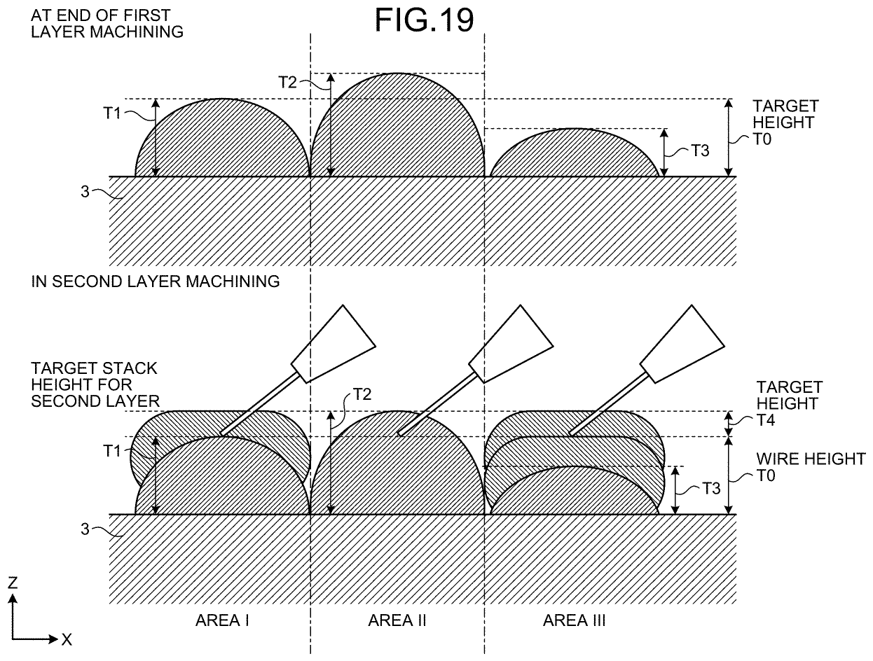

FIG. 19 is a diagram illustrating an example in which the machining condition that the additive manufacturing apparatus 100 illustrated in FIG. 1 controls is the number of ball beads. The situation at the end of the first layer machining is similar to that in FIG. 18. In the case of machining the second layer in area I with the target height of the second layer set to T4, the height T1, which is the measurement result of the first layer, is equal to the target height T0 of the first layer. The control unit 51 thus performs additive machining without changing the machining condition. In area II, the height T2, which is the measurement result, is greater than the target height T0 and close to the target height T0+T4 that should be reached at the end of the additive machining of the second layer. In area II, therefore, the control unit 51 does not perform the additive machining of the second layer. In area III, the height T3, which is the measurement result, is less than the target height T0, and the difference between the target height T0+T4 that should be reached at the end of the additive machining of the second layer and the height T3 is twice T4 or more. Thus, two layers of ball beads are continuously formed and stacked together. To sum up, on the basis of the difference between the target height and the measurement result, the control unit 51 changes the number of ball beads to be stacked. Changing the number of ball beads to be stacked is effective in dealing with an increase in the difference between the target height and the measurement result during the process of forming a stack of n layers. In addition, because precise height control is difficult only with the number of ball beads to be stacked, it is preferable to control the number of ball beads to be stacked in conjunction with changing other control parameters such as the wire supply speed.

FIG. 20 is a diagram illustrating a method in which the additive manufacturing apparatus 100 illustrated in FIG. 1 controls the wire height on the basis of the measurement result of the height of the object 4. The situation at the end of the first layer machining is similar to that in FIG. 18. For example, assume that the heights of the object 4 of the first layer in areas II and III are significantly different from the target height T0. If the wire height is increased by T0 in the additive machining of the second layer in areas II and III, the wire height relative to the additive target surface may be out of the allowable range ha±a. In such a case, it is preferable to control the wire height by changing the amount of rise of the drive stage 6 in the Z direction.

The wire height only needs to be set to T0 in the additive machining of the second layer in area I because the height T1, which is the measurement result of the first layer, is equal to the target height T0. In the case of machining the second layer in area II where the height T2, which is the measurement result, is greater than the target height T0, the wire height is out of the allowable range if the wire height is set to T0. In view of this, the wire height is set to T2, thereby making it possible to perform the additive machining of the second layer without causing machining failure. The wire height is out of the allowable range in the additive machining of the second layer in area III if the wire height is set to T0 because the height T3, which is the measurement result, is less than the target height T0. In view of this, the wire height is set to T3 for machining, thereby making it possible to perform the additive machining of the second layer without causing machining failure.

Adjusting the wire height on the basis of the measurement result of the height of the formed object 4, as described above, make it possible to prevent the occurrence of machining failure. The wire height is an example of a machining condition. It is preferable that the control of the wire height be performed in conjunction with the control of machining conditions for changing the stack height other than the wire height, e.g. the wire feed speed, the output of the machining laser 1, the emission time of the machining light 30, and the like.

When there is a large difference between the average height of the (n−1)-th layer and the target height T0 before the n-th layer is machined, the amount of change in the wire height to be increased may be set to the average height of the (n−1)-th layer, instead of the design value T0, at the end of the machining of the (n−1)-th layer.

To machine the n-th layer, machining conditions are controlled using the result of the immediately preceding measurement of the stack height of the (n−1)-th layer, such that the difference between the target height and the wire height can be maintained within the allowable range ha±α, as illustrated in FIG. 14. Thus, the machining can be continued without causing machining failure, and the creation accuracy of the object 4 can be improved.

The present embodiment has described the configuration in which the height sensor and the machining head 2 are integrated together. However, the height sensor and the machining head 2 need not be integrated. For the machining head 2 and a height sensor provided separately from the machining head 2, the drive stage 6 is moved such that the machining position coincides with the measurement position of the height sensor for the purpose of height measurement. After the height measurement by the height sensor, the drive stage 6 is moved such that the machining position coincides with the irradiation position of the machining light 30 for the purpose of machining. The height sensor and the machining head 2 integrated together enable a reduction in the time required for height measurement. Note that the height sensor in the present embodiment uses a line beam as the illumination light 40. In this regard, if the height sensor and the machining head 2 are not integrated together and the condenser lens 15 is not used for two purposes of machining and height measurement, it is preferable that the condenser lens 15 be an optical system capable of focusing only a line beam on the light receiver 16.

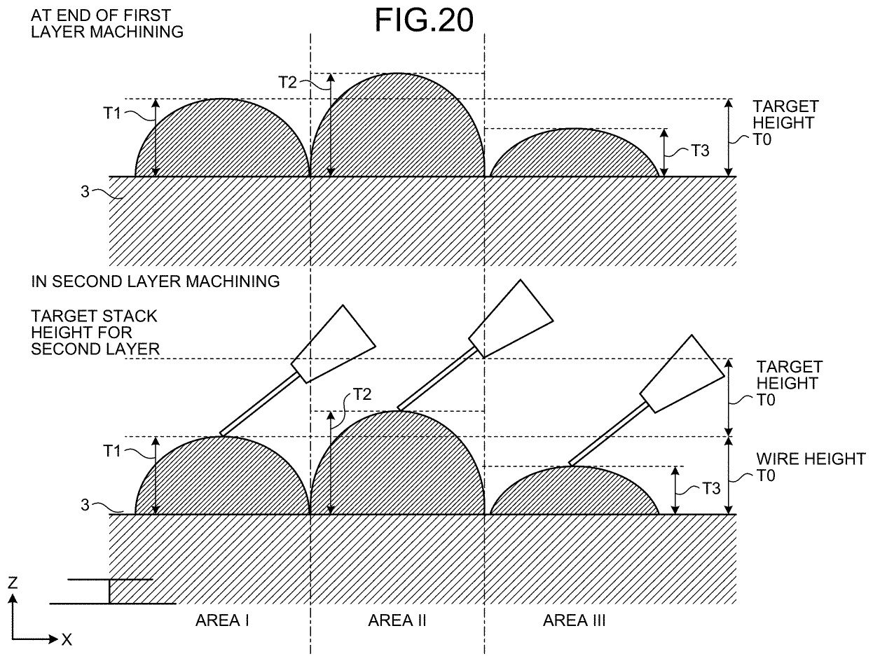

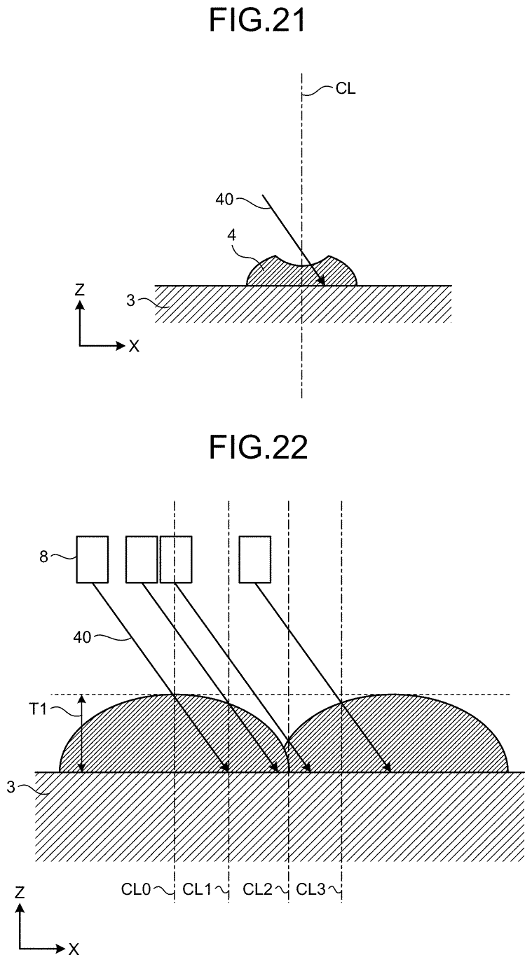

In the present embodiment, ball beads have a hemispherical shape, but can have any shape other than the hemispherical shape as long as a plurality of beads each made of one lump of the machining material 7 formed while the drive stage 6 is stationary are arranged to thereby form the object 4. FIG. 21 is a diagram illustrating a modification of the shape of a bead formed by the additive manufacturing apparatus 100 illustrated in FIG. 1. The exemplary bead illustrated in FIG. 21, which is a hemisphere having the center depressed, also enables highly accurate additive manufacturing through the use of the height sensor and the control of machining conditions according to the present embodiment. Beads having other shapes can also be used without any problem as long as the beads are formed in a ball shape.

In the present embodiment, the center of a ball bead is set as the machining position, but similar effects can be obtained even when the machining position is displaced from the center of a ball bead. FIG. 22 is a diagram illustrating a modification to the measurement position for measuring the height of the object 4 formed by the additive manufacturing apparatus 100 illustrated in FIG. 1. Assuming that the machining position for creating a deposit at the center of a ball bead as described in the present embodiment is CL0, machining conditions can be controlled on the basis of the result of measurement at CL0 as the measurement position of the illumination light 40. However, a deposit may be created at a position other than the center of a ball bead depending on the shape to be created. Possible examples include machining positions CL1 and CL3 on the curved surfaces of the ball beads illustrated in FIG. 22 and a machining position CL2 located at the connection between adjacent ball beads. In these cases, the bead height is less than the height T1 of the center of the ball bead. However, as described in the present embodiment, highly accurate machining can be performed by measuring the height of the object 4 formed at the machining position using the illumination light 40 which is a line beam, and controlling machining conditions.

Furthermore, in the present embodiment, the height of the formed object 4 is measured before one ball bead is formed, depositing is performed after the measurement, and movement to the next machining point is performed. However, the present embodiment is not limited to this example. For example, after the additive machining of a single layer is completed, the height of the formed object 4 defined by the entire single layer may be measured, and machining conditions may be controlled for the additive machining of the n-th layer on the basis of the measurement result.

In addition, in the present embodiment, because the machining point is moved in the X direction or the Y direction for depositing, it is not necessary to wait until the melted machining material 7 is completely solidified, and it is possible to measure the bead height in the (n−1)-th layer with the beads completely solidified. As a result, both improvement of measurement accuracy and reduction in machining time can be achieved. To achieve continuous depositing in the Z direction, the measurement of the height of the object 4 and the additive machining of the n-th layer are performed after a time for the bead in the (n−1)-th layer to be completely solidified elapses.

As described above, according to the first embodiment of the present invention, the practical height of the object 4 formed is measured, and machining conditions are controlled on the basis of the measurement result. As a result, the object 4 having a uniform height can be produced, and the shape accuracy of the object 4 can be improved.

### Second Embodiment.

Because the configuration of the additive manufacturing apparatus 100 according to the second embodiment of the present invention is the same as that of the additive manufacturing apparatus 100 according to the first embodiment illustrated in FIG. 1, a detailed description thereof will be omitted here. In addition, the additive manufacturing apparatus according to the second embodiment is denoted by 100, the reference sign used in the first embodiment. Hereinafter, differences from the first embodiment will be mainly described.

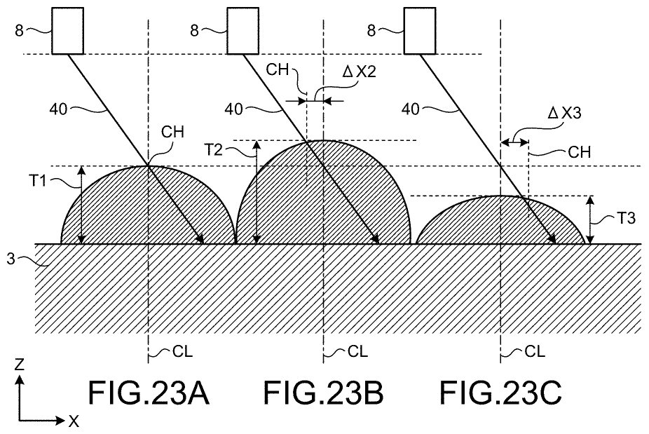

FIG. 23 is a diagram for explaining the problem to be solved by the additive manufacturing apparatus 100 according to the second embodiment of the present invention. In the present embodiment, the control unit 51 includes a machining position search unit that searches for the machining position when the height of the formed object 4 is measured. In the light section method that emits a line beam obliquely, the measurement position is displaced in the lateral direction in response to a change in the height of the object 4. However, the machining position search unit enables the height of the machining position to be measured with high accuracy regardless of object height.

FIG. 23(a) depicts a case where a ball bead is formed as designed at the target height T1. In the case of depositing the second layer, the machining head 2 is raised by the amount equivalent to the height T1 of the ball bead; therefore, moving the drive stage 6 to the position for measuring the machining position results in (machining position CL)=(measurement position CH), enabling the height of the object 4 to be measured at the machining position.

FIG. 23(b) depicts a case where the height T2 of a ball bead in the first layer is greater than the target height T1. In the case of depositing the second layer, raising the machining head 2 by T1 and moving the drive stage 6 to the position for measuring the machining position do not result in (machining position CL)=(measurement position CH), but cause a difference of ΔX2.

FIG. 23(c) depicts a case where the height T3 of a ball bead in the first layer is less than the target height T1. In the case of depositing the second layer, raising the machining head 2 by T1 and moving the drive stage 6 to the position for measuring the machining position do not result in (machining position CL)=(measurement position CH), but cause a difference of ΔX3.

As described above, in the light section method of radiating a line beam obliquely, a displacement of the height of the formed object 4 from the target height T1 causes a displacement of the measurement position. If the upper surface of the object 4 is flat, the influence of the displacement of the measurement position is small. However, if the object 4 has a curved shape like a ball bead, the displacement of the measurement position leads to a significant decrease in the measurement accuracy of the height of the object 4. The decrease in height measurement accuracy may result in the height of the wire relative to the additive target surface being out of the allowable range, which can cause machining failure. This description is about the light section method that emits a line beam obliquely, but the technique of the present embodiment is also applicable to a triangulation method that uses spot light, an interference method, or the like as in the method that emits light obliquely.

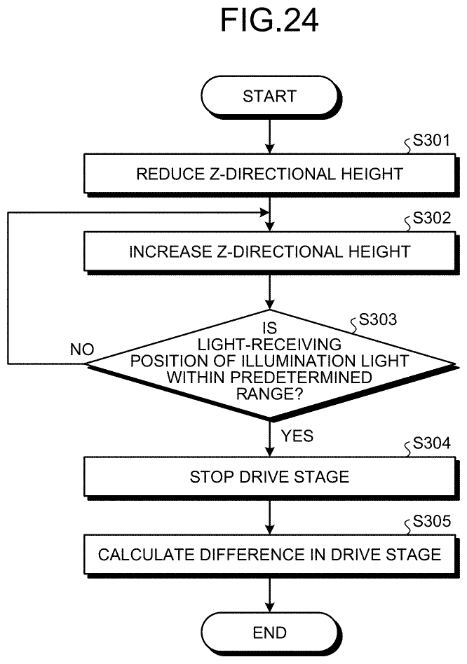

FIG. 24 is a flowchart for explaining machining position search process of the additive manufacturing apparatus 100 according to the second embodiment of the present invention. The machining position search process will be described with reference to FIGS. 25 to 33.

First, the additive manufacturing apparatus 100 moves the drive stage 6 to the position for measuring the height at the machining position, and starts measuring the height. FIG. 25 is a diagram illustrating the positional relationship between the measurement illumination unit 8 and a bead before the process of FIG. 24 starts. In this exemplary case, the practical height T2 of the object 4 is greater than the target height T0. When the height T2 is different from the target height T0, (machining position CL)=(measurement position CH) does not hold true, and the amount of displacement of the measurement position CH from the machining position CL is ΔX2.

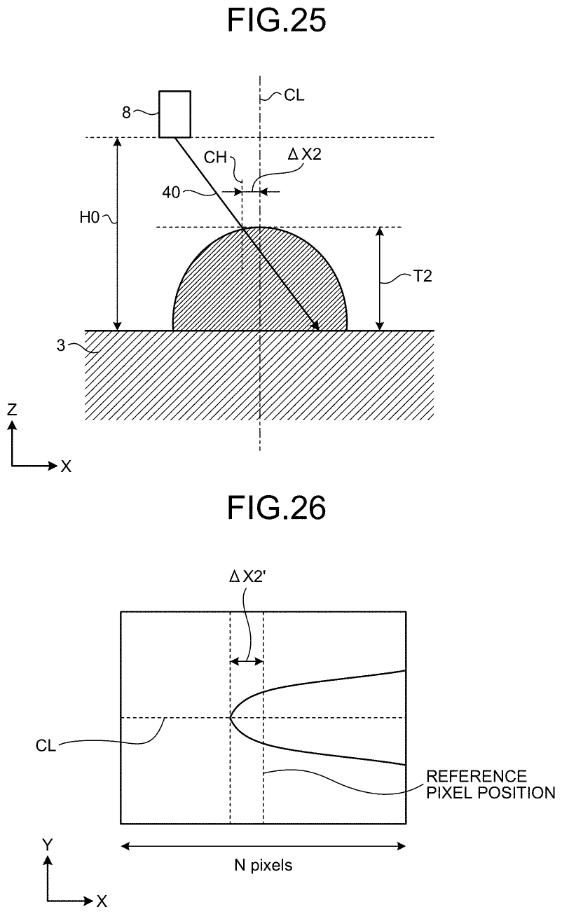

FIG. 26 is a diagram illustrating the light-receiving position on the light-receiving element in the state illustrated in FIG. 25. In correspondence to the amount of displacement ΔX2 of the illumination light 40 which is a line beam, an amount of displacement ΔX2′ of the light-receiving position relative to the reference pixel position is generated in the X direction. ΔX2′=M×ΔX2 holds true.

Reference is made back to FIG. 24. The machining position search unit of the control unit 51 moves the drive stage 6 to reduce the Z-directional height by a certain amount (step S301). Since the drive stage 6 is moved, the reduction in the Z-directional height is achieved by raising the drive stage 6 in the Z direction. The amount of reduction in height is the lower limit of the height measurement range determined by the number of pixels of the light-receiving element illustrated in FIG. 16. The amount of reduction can be freely set in accordance with the height range of the ball bead to be measured.

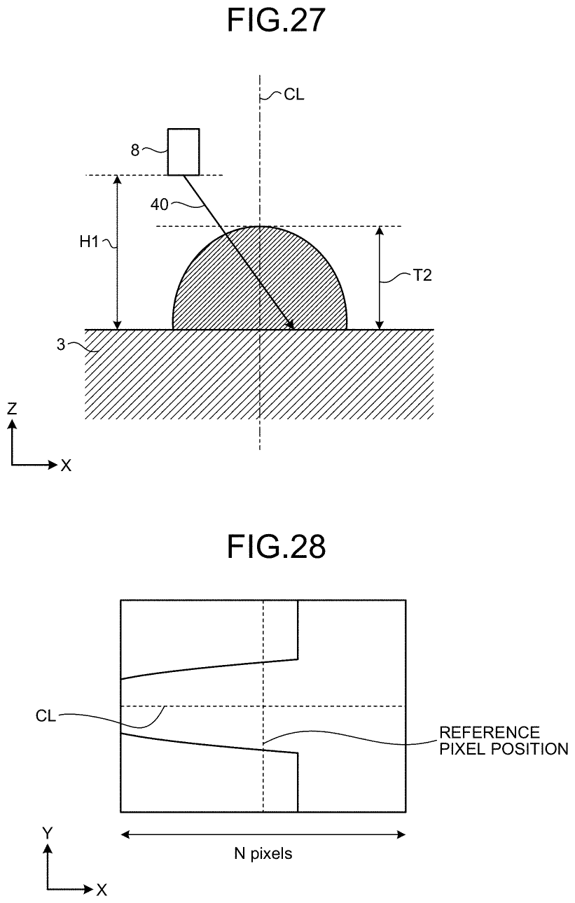

FIG. 27 is a diagram illustrating the positional relationship between the measurement illumination unit 8 and the workpiece 3 after step S301 in FIG. 24. Moving the drive stage 6 from the state illustrated in FIG. 25 reduces the height of the measurement illumination unit 8 relative to the workpiece 3 from H0 to H1. The amount of reduction H0−H1 is half the height measurement range: Zr/2=N×tan θ/M/2. FIG. 28 is a diagram illustrating the light-receiving position on the light-receiving element in the state illustrated in FIG. 27.

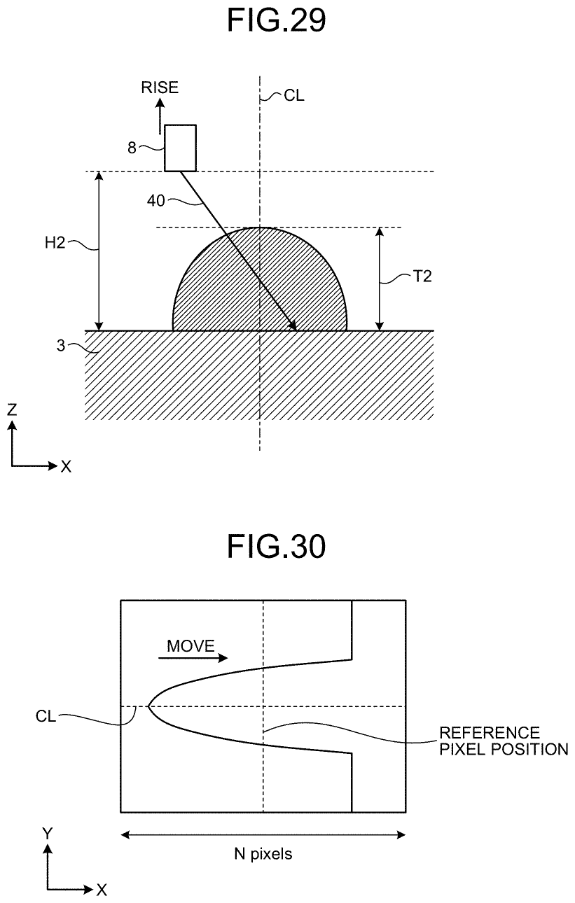

Reference is made back to FIG. 24. The machining position search unit of the control unit 51 increases the Z-directional height (step S302). FIG. 29 is a diagram illustrating the positional relationship between the measurement illumination unit 8 and the workpiece 3 after step S302 in FIG. 24. Moving the drive stage 6 from the state illustrated in FIG. 27 increases the height of the measurement illumination unit 8 relative to the workpiece 3 from H1 to H2. FIG. 30 is a diagram illustrating the light-receiving position on the light-receiving element in the state illustrated in FIG. 29. As illustrated in FIG. 30, as the height of the measurement illumination unit 8 relative to the workpiece 3 is increased, the light-receiving position of the illumination light 40 on the light-receiving element is moved in the +X direction.

Although the method of reducing and then increasing the height of the measurement illumination unit 8 relative to the workpiece 3 has been described here, the height of the measurement illumination unit 8 relative to the workpiece 3 may be increased and then reduced.

Reference is made back to FIG. 24. The machining position search unit of the control unit 51 determines whether the light-receiving position of the illumination light 40 reflected from the object 4 at the machining position is within a predetermined range on the light-receiving element (step S303).

FIG. 31 is a diagram illustrating a predetermined range L used in step S303 of FIG. 24. The range L is a range that depends on the accuracy of the height of the object 4 to be measured with respect to the reference pixel position. For example, the height displacement amount ΔZ′ per pixel can be determined using the formula ΔZ′=P tan θ/M.

Reference is made back to FIG. 24. When determining that the light-receiving position of the illumination light 40 is within the predetermined range L (step S303: Yes), the machining position search unit of the control unit 51 stops the drive stage 6 (step S304). When determining that the light-receiving position of the illumination light 40 is not within the predetermined range L (step S303: No), the machining position search unit of the control unit 51 returns to step S302.

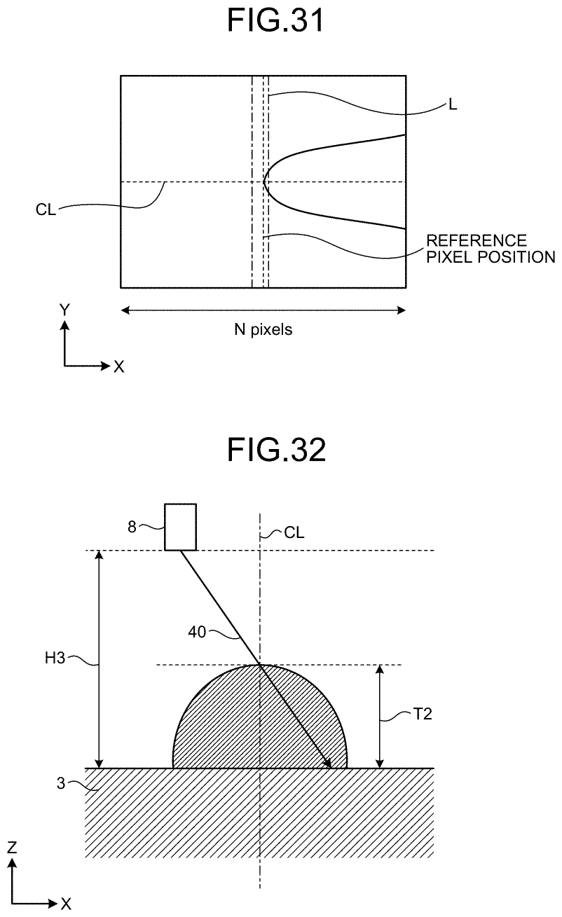

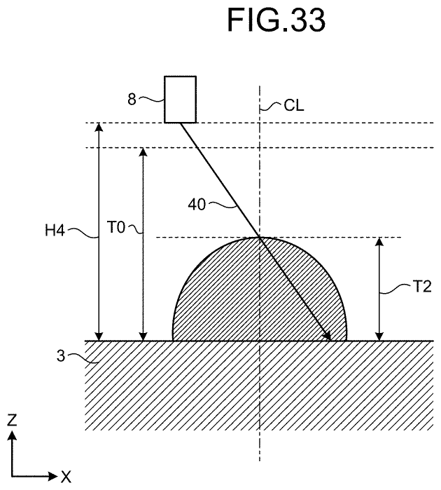

FIG. 32 is a diagram in which the drive stage 6 stops in step S304 of FIG. 24. If the light-receiving position enters the range L as illustrated in FIG. 31 when the height of the measurement illumination unit 8 relative to the workpiece 3 is H3 as illustrated in FIG. 32, the drive stage 6 stops.

FIG. 33 is a diagram for comparing the state before the process of FIG. 24 and the state after step S304. H0 in FIG. 33 indicates the height of the measurement illumination unit 8 relative to the workpiece 3 before the process of FIG. 24. H3 in FIG. 33 indicates the height of the measurement illumination unit 8 relative to the workpiece 3 after in step S304 of FIG. 24.

The height measurement unit calculates the difference H3−H0 between the heights H3 and H0, which is the difference in the height of the drive stage 6 (step S305). Consequently, the difference in the height of the object 4 from the target height can be obtained as T2−T0=H3−H0.

As described above, even though the light section method that emits a line beam obliquely entails a displacement of the measurement position from the machining position due to a change in the height of the object 4, the machining position search unit enables the height of the object 4 to be measured at the machining position.

### Third Embodiment

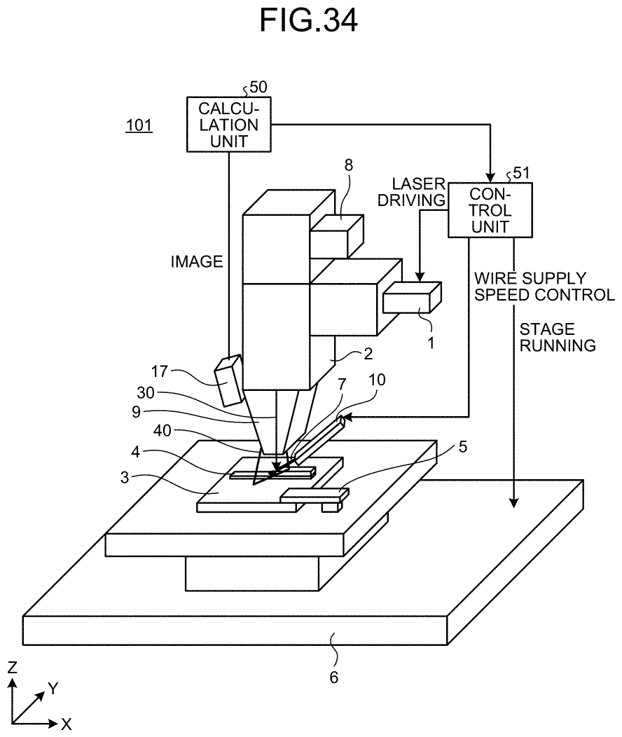

FIG. 34 is a diagram illustrating a configuration of an additive manufacturing apparatus 101 according to the third embodiment of the present invention. The additive manufacturing apparatus 101 is different from the additive manufacturing apparatus 100 according to the first embodiment in the arrangement of the measurement illumination unit 8 and the imaging system. The third embodiment differs from the first embodiment in respects as will be hereinafter mainly described, and the description of similarities to the first embodiment will be omitted.

In the additive manufacturing apparatus 101, the measurement illumination unit 8 projects, in parallel with the optical axis of the machining light 30, the illumination light 40 which is a line beam. The light-receiving unit 17 receives the reflected light reflected in an oblique direction. This prevents the measurement position of the line beam from being displaced as described in the second embodiment; therefore, the height of the object 4 can be measured with high accuracy without the machining position search process.

In the additive manufacturing apparatus 101, the measurement illumination unit 8 is incorporated in the machining head 2, and the light-receiving unit 17 including the light-receiving optical system and the light-receiving element is attached to a side surface of the machining head 2.

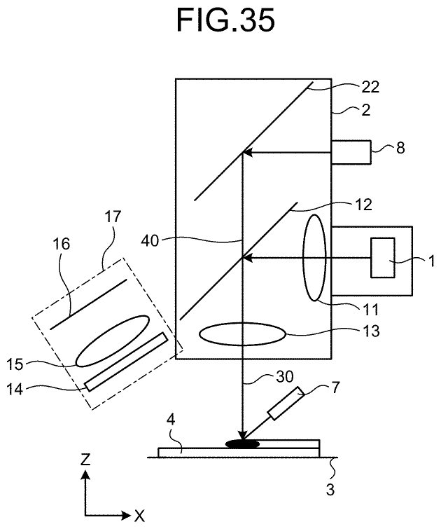

FIG. 35 is a diagram illustrating the internal configuration of the machining head 2 illustrated in FIG. 34. FIG. 35 depicts an XZ cross-section of the additive manufacturing apparatus 101. The machining head 2 includes the light-projecting lens 11, the beam splitter 12, the objective lens 13, a beam splitter 22, and the measurement illumination unit 8. Because the machining optical system is the same as that of the first embodiment, a detailed description thereof will be omitted.

The illumination light 40 output from the measurement illumination unit 8 is reflected by the beam splitter 22 through the objective lens 13 onto the machining position on the object 4, which is the measurement position. In order to allow light to pass through the objective lens 13 for machining, the measurement illumination unit 8 emits a beam having a characteristic of being concentrated on the object 4 through the objective lens 13. As in the first embodiment, the illumination light 40 need not necessarily be a line beam, and may be a spot beam concentrated in a point shape.

The light-receiving unit 17 includes the condenser lens 15 and the light receiver 16. Preferably, the light-receiving unit 17 further includes the bandpass filter 14 that selectively transmits the irradiation wavelength of the illumination light 40.

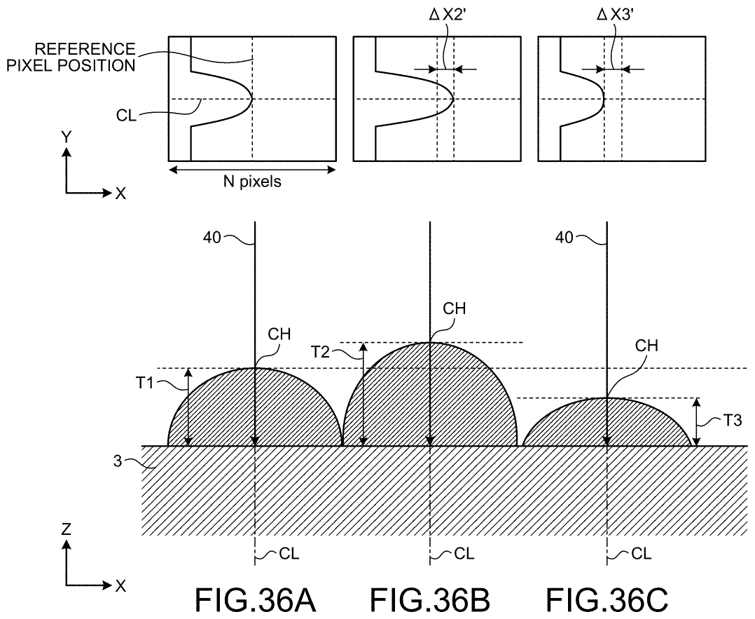

FIG. 36 is a diagram for explaining height measurement in the additive manufacturing apparatus 101 illustrated in FIG. 34. FIG. 36(a) depicts a ball bead created with the target height T1. FIG. 36(b) depicts a ball bead created with a height greater than the target height T1. FIG. 36(c) depicts a ball bead created with a height less than the target height T1. The illumination light 40 is emitted coaxially with the machining light 30. The measurement position CH therefore coincides with the machining position CL.

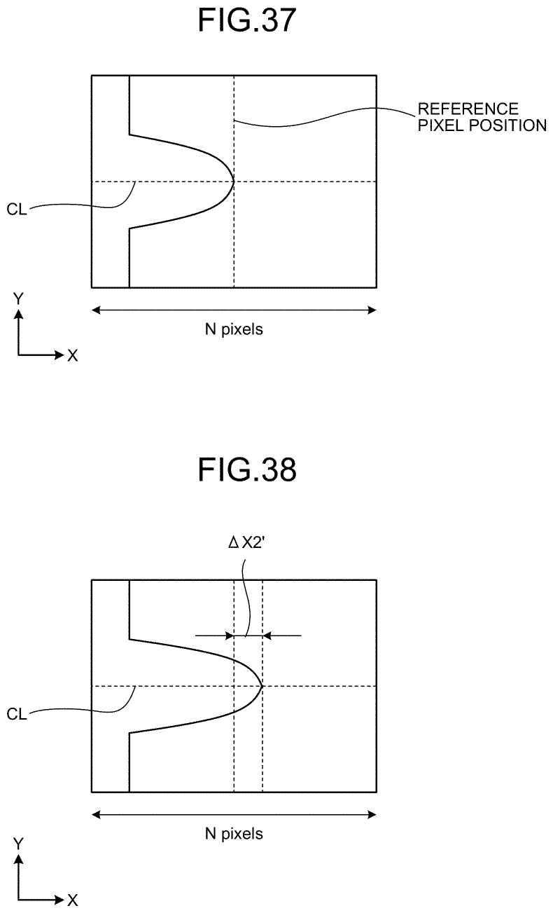

FIG. 37 is a diagram illustrating the light-receiving position of reflected light from the bead illustrated in FIG. 36(a). In the case of performing the additive machining of the second layer on the ball bead created with the target height T1 illustrated in FIG. 36(a), the machining head 2 is raised by T1; therefore, the Y-directional light-receiving position corresponding to the machining position on the light-receiving element of the light receiver 16 is the reference pixel position.

FIG. 38 is a diagram illustrating the light-receiving position of reflected light from the bead illustrated in FIG. 36(b). In the case of the ball bead formed with the height T2 greater than the target height T1 illustrated in FIG. 36(b), raising the machining head 2 by T1 causes the Y-directional light-receiving position on the light-receiving element to be displaced by ΔX2′ from the reference pixel position. Using the value of ΔX2′ and the principle of triangulation, T2-T1 can be calculated.

FIG. 39 is a diagram illustrating the light-receiving position of reflected light from the bead illustrated in FIG. 36(c). In the case of the ball bead formed with the height T3 less than the target height T1 illustrated in FIG. 36(c), raising the machining head 2 by T1 causes the Y-directional light-receiving position on the light-receiving element to be displaced by ΔX3′ from the reference pixel position. Using the value of ΔX3′ and the principle of triangulation, T1−T3 can be calculated.

As described above, the additive manufacturing apparatus 101 according to the present embodiment projects the illumination light 40 for height measurement in parallel with the optical axis of the machining light 30, and includes the light-receiving unit 17 provided in an oblique direction relative to the optical axis. This configuration enables the measurement position of the illumination light 40 to be kept at the machining position regardless of changes in the height of ball beads. The height of the machining position can be therefore measured with high accuracy regardless of the height of the object 4.

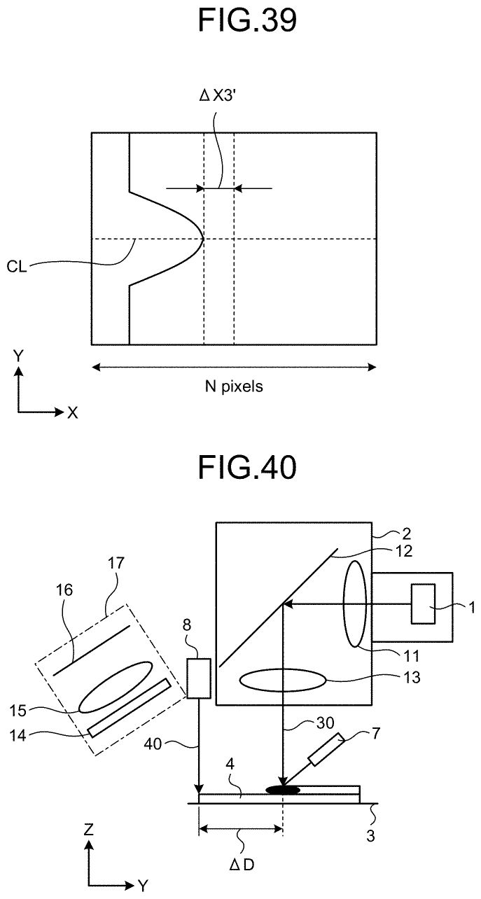

FIG. 40 is a diagram illustrating a modification to the additive manufacturing apparatus 101 illustrated in FIG. 35. The present embodiment is not limited to the exemplary configuration in FIG. 35, in which the measurement illumination unit 8 is integrated with the machining head 2. As illustrated in FIG. 40, the measurement illumination unit 8 and the machining head 2 may be separate from each other. In this case, there is a difference AD between the optical axis of the illumination light 40 emitted from the measurement illumination unit 8 and the optical axis of the machining light 30. For height measurement, therefore, the drive stage 6 is moved by the difference AD between the machining position and the measurement position, whereby the height of the object 4 at the machining position can be measured with high accuracy.

The configurations described in the above-mentioned embodiments indicate examples of the contents of the present invention. The configurations can be combined with another well-known technique, and some of the configurations can be omitted or changed in a range not departing from the gist of the present invention.

### REFERENCE SIGNS LIST

1 machining laser; 2 machining head; 3 workpiece; 4 object; 5 fixture; 6 drive stage; 7 machining material; 8 measurement illumination unit; 9 gas nozzle; 10 machining material supply unit; 11 light-projecting lens; 12 beam splitter; 13 objective lens; 14 bandpass filter; 15 condenser lens; 16 light receiver; 17 light-receiving unit; 20 lower limit; 21 upper limit; 30 machining light; 40 illumination light; 50 calculation unit; 51 control unit; 71 droplet; 72 melting residue; 100 additive manufacturing apparatus; 190 processing circuitry; 200 control circuit; 200a processor; 200b memory.

1.-20. (canceled)

21. An additive manufacturing apparatus to form an object by repeating additive machining of melting a machining material and adding, onto a workpiece, the machining material solidified, the additive manufacturing apparatus comprising:
a drive stage to change a positional relationship between the workpiece and a machining head that executes the additive machining, and stop at a plurality of machining points;
a height measurer to, each time the drive stage stops at one of the machining points, measure a height of the object formed at the machining point as the drive stage stops; and
a controller to control a machining condition for adding the machining material to the machining point on a basis of a measurement result provided by the height measurer.

22. The additive manufacturing apparatus according to claim 21, wherein the controller controls the machining condition such that the machining material to be added to the machining point has a height equal to a difference between a target height and the measurement result.

23. The additive manufacturing apparatus according to claim 21, wherein
the object is formed by repeating:
a first operation of measuring a height of the object formed at a first machining point;
a second operation of melting the machining material supplied to the first machining point while controlling the machining condition on the basis of the measured height of the object at the first machining point, the second operation being executed after the first operation; and
a third operation of moving a supply position of the machining material from the first machining point to a second machining point that is a machining point next to the first machining point, the third operation being executed after the second operation.

24. The additive manufacturing apparatus according to claim 23, wherein movement from the first machining point to the second machining point involves movement in a direction orthogonal to a height direction of the object.

25. The additive manufacturing apparatus according to claim 21, wherein at least a part of the object is created using a bead that is formed from the machining material melted at a machining point.

26. The additive manufacturing apparatus according to claim 21, wherein the height measurer includes: a measurement illuminator to irradiate a measurement position with measurement illumination light; and a light receiver to receive reflected light that is the measurement illumination light reflected at the measurement position, and the height measurer calculates the height of the object formed on the workpiece on the basis of a light-receiving position of the reflected light on the light receiver.

27. The additive manufacturing apparatus according to claim 26, wherein
the height measurer includes a light-receiving optical system to concentrate the reflected light on the light receiver, and
the light-receiving optical system is integrated with a machining optical system to focus, on a machining point, machining light for melting the machining material.

28. The additive manufacturing apparatus according to claim 26, wherein the measurement position is within a field of view of a light-receiving element of the light receiver.

29. The additive manufacturing apparatus according to claim 26, wherein the measurement illumination light is a line beam emitted linearly.

30. The additive manufacturing apparatus according to claim 21, comprising a machining optical system to focus, on a machining point, machining light for melting the machining material.

31. The additive manufacturing apparatus according to claim 21, wherein the controller reduces an amount of supply of the machining material to a machining point when the measurement result is higher than a predetermined target height, and increases the amount of supply when the measurement result is lower than the target height.

32. The additive manufacturing apparatus according to claim 26, wherein the controller reduces an output of machining light for melting the machining material when the measurement result is higher than a predetermined target height, and increases the output of the machining light when the measurement result is lower than the target height.

33. The additive manufacturing apparatus according to claim 26, wherein the controller reduces an emission time of machining light for melting the machining material when the measurement result is higher than a predetermined target height, and increases the emission time of the machining light when the measurement result is lower than the target height.

34. The additive manufacturing apparatus according to claim 21, wherein the controller reduces a number of times a deposit is created at the machining point when the measurement result is higher than a predetermined target height, and increases the number of times a deposit is created at the machining point when the measurement result is lower than the target height.

35. The additive manufacturing apparatus according to claim 21, wherein the controller increases a height of an end of the machining material in accordance with a predetermined target height, and the controller increases an amount of increase in the height of the end before melting when the measurement result is higher than the target height, and reduces the amount of increase in the height of the end before melting when the measurement result is lower than the target height.

36. The additive manufacturing apparatus according to claim 26, wherein
the controller changes a height of the measurement illuminator relative to the workpiece, and
the height measurer measures the height of the object formed at the machining point on the basis of the light-receiving position obtained while the height of the measurement illuminator relative to the workpiece is changed.

37. The additive manufacturing apparatus according to claim 26, wherein an optical axis of the measurement illumination light is parallel with an optical axis of machining light.

38. An additive manufacturing method for forming an object on a workpiece by repeating additive machining of melting a machining material and adding, onto the workpiece, the machining material solidified, the additive manufacturing method comprising:
changing a positional relationship between the workpiece and a machining head that executes the additive machining, and stopping at a plurality of machining points;
whenever stopping at one of the machining points, measuring a height of the object formed at the machining point at a time of the stop; and
controlling a machining condition for adding the machining material to the machining point on a basis of a measurement result of the height of the object formed.

39. A non-transitory storage medium to store an additive manufacturing program for causing a computer to execute an additive manufacturing process of forming an object on a workpiece by repeating additive machining of melting a machining material and adding, onto the workpiece, the machining material solidified, the additive manufacturing process comprising:
changing a positional relationship between the workpiece and a machining head that executes the additive machining and stopping at a plurality of machining points;
whenever stopping at one of the machining points, measuring a height of the object formed at the machining position on the workpiece at a time of the stop; and
controlling a machining condition for adding the machining material to the machining position on a basis of a measurement result of the height of the object formed.
